(19) United States
(12) Patent Application Publication
(10) Pub. No.: US 2020/0321822 A1
(43) Pub. Date: Oct. 8, 2020

(54) MOTOR PART AND ELECTRIC COMPRESSOR INCLUDING THE SAME

(71) Applicant: LG Electronics Inc., Seoul (KR)

(72) Inventors: Woogyong YIM, Seoul (KR); Jehoon KIM, Seoul (KR); Ochang GWON, Seoul (KR); Kyoungjun PARK, Seoul (KR)

(73) Assignee: LG Electronics Inc., Seoul (KR)

(21) Appl. No.: 16/688,231

(22) Filed: Nov. 19, 2019

(30) Foreign Application Priority Data
Apr. 5, 2019 (KR) 10-2019-0040409

(51) Int. Cl. H02K 3/52; H02K 1/14; H02K 5/08; H02K 3/34; H02K 3/28; H02K 1/16; F04C 23/02; H02P 27/06; H02K 15/10

(52) U.S. Cl. CPC H02K 3/522; H02K 1/148; H02K 5/08; H02K 3/34; H02K 2203/12; H02K 1/16; F04C 23/02; H02P 27/06; H02K 15/10; H02K 3/28

(57) ABSTRACT

The present disclosure provides a motor part comprising a bobbin part comprising a plurality of coils housed therein, a first insulation part adjacent to an inner circumferential surface of the motor chamber, and a second insulation part spaced a predetermined distance from the first insulation part. The plurality of coils are housed in a coil housing spare part formed between the first insulation part and the second insulation part. The first insulation part is located between the inner circumferential surface of the motor chamber and the plurality of coils. The plurality of coils are located adjacent to the second insulation part. Accordingly, insulation caused by separation from the inner circumferential surface of the motor chamber and insulation caused by the first insulation part may be expected. The insulation may be achieved by the plurality of coils being housed in the bobbin part.

### CROSS-REFERENCE TO RELATED APPLICATION

This application claims the benefit of priority under 35 U.S.C. § 119(a) to Korean Patent Application No. 10-2019-0040409, filed on Apr. 5, 2019, the disclosure of which is incorporated by reference herein in its entirety.

### BACKGROUND

### 1. Technical Field

The present disclosure relates to a motor part and an electric compressor including the same, and more particularly, to a motor part having an enhanced degree of freedom of design for a stator of the motor part by changing a winding position of a coil included in the stator and an electric compressor including the same.

### 2. Background

Compressors serving to compress refrigerant in air conditioning systems for vehicle have been developed in various forms. In recent years, electric compressors (motor-operated compressors) driven by electric power using motors have been actively developed according to the tendency of electrification of vehicle components.

A motor-operated compressor generally employs a scroll-compression method which is suitable for a high compression ratio operation. Such a scroll-type motor-operated compressor (hereinafter, referred to as “motor-operated compressor”) includes a motor part, a compression part, and a rotating shaft connecting the motor part and the compression part.

Specifically, the motor part is configured as a rotary motor or the like, and installed inside a hermetic casing. The compression part is located at one side of the motor part, and is provided with a fixed scroll and an orbiting scroll. The rotating shaft is configured to transmit rotational force of the motor part to the compression part.

The refrigerant compressed in the compression part is exhausted to outside of the electric compressor through an exhaust port. The exhausted refrigerant is utilized for operating an air conditioning system for vehicle.

An electric part includes a stator and a rotor. A plurality of coils are wound around the stator. Also, a magnet is provided in the rotor. The magnet provided in the rotor is generally a permanent magnet.

When power is applied to the electric part, a magnetic field is formed by the plurality of coils wound around the stator. The formed magnetic field exerts electromagnetic force on the magnet provided in the rotor. Thus, the rotor having the magnet is rotated according to the strength and direction of the electromagnetic force.

Referring to FIG. 1, an electric part according to a conventional technique includes a stator S and a rotor R.

The stator S includes a yoke including a plurality of toothed parts. A plurality of coils C are wound around the toothed parts. The distal ends of each of the coils C wound around the toothed parts are defined as end turns E and are located on an upper side and a lower side of the corresponding stator S.

Also, the coils C through which currents having different phases flows have to be wound around the toothed parts. Accordingly, a coil extending from the end turn E passes through a tooth wound by the coil C and proceeds to another tooth.

In this case, the coil C extends along the outer circumferential surface of an insulator I in the electric part according to the related art. In other words, the coil C proceeds to another toothed part through a space between a housing H and the insulator I.

Accordingly, there is a need to prevent a current flowing through the coil C from leaking to the housing H. The electric part according to the related art accomplishes the need by separating the housing H and the insulator I.

That is, the electric part according to the related art is configured to secure an interval between the insulator I adjacent to the housing H and the inner surface of the housing H (which is referred to as an “insulation interval”) in order to prevent the current flowing through the coil C from being delivered to the inner surface of the housing H.

However, the insulating scheme according to the related art has the following limitations.

First, the insulation interval varies depending on the magnitude of power applied to the electric part. For example, when a voltage of 800 V is applied, an insulation distance d of about 5.5 mm should be secured. On the other hand, when a voltage of 400V is applied, an insulation distance d of about 2.5 mm is needed.

Accordingly, since a change in design should be performed according to the magnitude of applied power, it is difficult to cope with various power sources.

Also, in order to secure an insulation distance d of a coil C extending between toothed parts, the shape of a yoke included in the stator S is limited. In detail, a coil C extending from an end turn E has to be moved to the outer circumferential surface of an insulator I. Accordingly, the yoke included in the stator S must at least have an outer circumferential surface thicker than the insulation interval.

Accordingly, since constraints are added when the yoke is designed, there is a limitation in that the degree of freedom of design for the yoke is reduced. Furthermore, due to the space occupied by the outer circumferential surface of the yoke, the density per unit area of the coil C wound around the stator is decreased. Thus, the output power performance of the electric part is degraded, and thus there is another limitation in which the size of the electric part should be increased in order to implement the same output power performance.

In addition, as described above, the insulation interval varies depending on the magnitude of applied power. Accordingly, there is a limitation in that the shape of the yoke must be changed in design depending on the size of the power.

Such a change in design is not only difficult because it needs to cope with various power sources, but also increases manufacturing cost and time.

Korean Patent No. 10-1506095 discloses an electric compressor including an inter-phase insulating sheet. In detail, this document discloses an electric compressor having a structure including an insulating part for performing the inter-phase insulation between coil ends of coils protruding from both ends of a stator core.

However, this type of electric compressor has a limitation in that an insulating sheet should be separately formed because each insulating sheet is inserted into a coil end. Also, the electric compressor has a limitation in that a separate member is needed to insert and engage the insulating sheet with the coil end.

Korean Patent Publication No. 10-2001-0104811 discloses a motor stator insulation structure of a compressor including an insulating paper. In detail, there is disclosed a motor stator insulation structure in which insulation is maintained even when a coil is loosened due to high temperature by inserting the insulation paper for preventing withstand voltage between the coil and an iron core wound with the coil.

However, such a type of motor stator insulation structure has a limitation in that separate insulation paper should be provided for insulation. Also, insulation paper is not located between a coil and a housing but between a coil and an iron core. Accordingly, the motor stator insulation structure has another limitation in that insulation performance between a coil and a housing is not considered.

### RELATED ART DOCUMENTS

### Patent Documents

Korean Patent No. 10-1506095 (Mar. 25, 2015)

Korean Publication No. 10-2001-0104811 (Nov. 28, 2001)

### SUMMARY

The present disclosure provides a motor part having a structure capable of solving the above problems and an electric compressor including the same.

First, the present disclosure provides a motor part having a structure capable of improving insulation performance between a housing and a stator without adding a separate member, and an electric compressor including the same.

Also, the present disclosure provides a motor part having a structure that does not need to secure an insulation distance for insulation between a housing and a coil extending to each toothed part, and an electric compressor including the same.

Also, the present disclosure provides a motor part having a structure that has no limitations on the design of a yoke forming a stator to achieve insulation between a housing and a coil extending to each toothed part, and an electric, compressor including the same.

Also, the present disclosure provides a motor part having a structure that does not need to increase the thickness of the outer circumferential surface of the yoke in order to achieve insulation between a housing and a coil extending to each toothed part, and an electric compressor including the same.

Also, the present disclosure provides a motor part having a structure that does not need a change in design even when various magnitudes of power are applied.

Also, the present disclosure provides a motor part having a structure capable of improving output power by securing a sufficient number of coils to be wound around a stator, and an electric compressor including the same.

Also, the present disclosure provides an electric compressor capable of preventing an insulator provided for insulation between a housing and a coil extending to each toothed part from being broken down.

Also, the present disclosure provides a motor part having a structure capable of improving output power without increasing magnitude and an electric compressor including the same.

There is provided a motor part comprising a stator comprising a circular section with a predetermined space formed therein and a yoke extending in a length direction, a plurality of coils wound around the stator, and a rotor housed in the predetermined space and spaced a predetermined distance from the stator. The rotor may be configured to rotate relative to the stator. The stator may comprise a bobbin part located on one side of the length direction of the stator and extending along a circumferential direction of the yoke, and the bobbin part may comprise a first insulation part forming an outer circumference of the bobbin part and a second insulation part forming an inner circumference of the bobbin part. The plurality of coils may be located between the first insulation part and the second insulation part and wound in a circumferential direction of the bobbin part.

Also, the yoke of the motor part may comprise a yoke-specific outer circumference part forming an outer circumference of the yoke; a plurality of toothed parts protruding toward a center of the yoke from the yoke-specific outer circumference part and spaced a predetermined distance from one another along the outer circumference of the yoke; and a plurality of coil winding space parts formed between the plurality of toothed parts.

The stator of the motor part may further comprise a first coil end turn and a second coil end turn, each formed by winding any one of the plurality of coils around the plurality of toothed parts. The first coil end turn may be located on the one side in the length direction of the stator and the second coil end turn may be located on a side opposite to the one side between the first insulation part and the second insulation part.

Also, the plurality of coils of the motor part may be located adjacent to the second insulation part, and at least one of the first and second coil end turns may be spaced a predetermined distance from the plurality of coils and located adjacent to the first insulation part.

Also, the plurality of coils of the motor part may be configured to allow currents of different phases to flow therethrough, and the plurality of coils wound in the circumferential direction of the bobbin part may be spaced a predetermined distance from one another to block an electrical connection between the plurality of coils.

Also, the currents flowing through the plurality of coils of the motor part may have any one of U-phase, V-phase, and W-phase, and the plurality of coils may be wound around each of the plurality of teeth parts, and each of the plurality of coils may be wound around any one of the plurality of toothed parts such that a phase of a current flowing through a coil wound around a corresponding one of the plurality of toothed parts may be alternately changed in the circumferential direction of the yoke.

Also, the first insulation part and the second insulation part of the motor part may extend in the length direction of the stator, and an extension length of the first insulation part may be smaller than or equal to an extension length of the second insulation part.

Also, the plurality of coils of the motor part may be located adjacent to the second insulation part, and the second insulation part may include a rigidity reinforcement unit may be configured to reinforce a rigidity of the second insulation part.

Also, a rigidity reinforcement part of the motor part may comprise an area reinforcement member configured to increase a cross-sectional area of the second insulation part toward a center of the stator.

Also, the rigidity reinforcement unit of the motor part may comprise one side surface of the second insulation part toward the first insulation part; and an inner reinforcement member extending at a predetermined angle with respect to the one side surface of the second insulation part and contacting a side located adjacent to the one side surface in the length direction of the stator.

Also, the plurality of coils wound in the circumferential direction of the bobbin part of the motor part may be spaced a predetermined distance from one another to block an electrical connection between the plurality of coils, and the rigidity reinforcement unit may include a gap reinforcement member provided in each space formed by the plurality of coils being spaced the predetermined distance from one another.

Also, there is provided an electric compressor including a motor part; a main housing comprising a motor chamber therein to house the motor part; an inverter located on one side of the main housing, the inverter comprising an inverter device housed therein and configured to control the motor part; and a compression part configured to be rotated by a rotational force generated due to a rotation of the motor part and compress refrigerant. The motor part may comprise a stator comprising a circular section with a predetermined space formed therein and a yoke extending in a length direction; a plurality of coils wound around the stator; and a rotor housed in the predetermined space and spaced a predetermined distance from the stator, the rotor being configured to rotate relative to the stator. The stator may comprise a bobbin part located on one side in the length direction of the stator and extending along a circumferential direction of the yoke, the bobbin part comprising a first insulation part forming an outer circumference of the bobbin part and a second insulation part forming an inner circumference of the bobbin part, and the plurality of coils are located between the first insulation part and the second insulation part and wound in a circumferential direction of the bobbin part.

Also, the outer circumferential surface of the stator of the electric compressor may be configured to contact an inner circumferential surface of the motor chamber of the main housing, and one side surface of the first insulation part of the bobbin part may be configured to contact the inner circumferential surface of the motor chamber.

Also, the yoke of the electric compressor may comprise a yoke-specific outer circumference part forming an outer circumference of the yoke; a plurality of toothed parts protruding toward a center of the yoke from the yoke-specific outer circumference part and spaced a predetermined distance from one another along the outer circumference of the yoke; and a plurality of coil winding space parts formed between the plurality of toothed parts.

The stator of the electric compressor may comprise a first coil end turn and a second coil end turn, each formed by winding any one of the plurality of coils around the plurality of toothed parts, and the first coil end turn may be located on the one side in the length direction of the stator and the second coil end turn may be located on a side opposite to the one side between the first insulation part and the second insulation part.

Also, the plurality of coils of the electric compressor may be configured to allow currents of different phases to flow therethrough, and the plurality of coils wound in the circumferential direction of the bobbin part may be spaced a predetermined distance from one another to block an electrical connection between the plurality of coils.

Also, the currents flowing through the plurality of coils of the electric compressor may have any one of U-phase, V-phase, and W-phase, and the plurality of coils may be wound around each of the plurality of toothed parts, and each of the plurality of coils may be wound around any one of the plurality of toothed parts such that a phase of a current flowing through a coil wound around a corresponding one of the plurality of toothed parts is alternately changed in the circumferential direction of the yoke.

Also, the plurality of coils of the electric compressor may be located adjacent to the second insulation part, and the second insulation part may comprise a rigidity reinforcement unit configured to reinforce a rigidity of the second insulation part.

### Advantageous Effects

According to the present disclosure, the following effects can be achieved.

First, insulation parts may be provided in a bobbin part provided in a stator. The insulation parts may be spaced apart from one another to form a predetermined space therebetween. Coils extending to toothed parts may be housed in the predetermined space.

Accordingly, it may be possible to improve insulation performance between a housing and a stator without a separate member.

Also, the insulation parts provided in the bobbin part may be spaced apart from one another. An insulation part on one side adjacent to a housing may be brought into contact with the inner surface of the housing. The coils may be housed in the space between the insulation parts. The coils may be located adjacent to the insulation part on the other side opposite to the one side adjacent to the housing.

Accordingly, it may be possible to secure sufficient insulation performance without spacing the inner surface of the housing and the coil apart from each other. Thus, an insulation distance may not be needed for insulation between a housing and a coil extending to each toothed part.

Also, the coils extending to the toothed parts may be housed in a space formed by the insulation parts provided in the bobbin part. The coils extending to the toothed parts and also the end turns of the coils may be housed in the space.

Accordingly, there may be no need to change the design of a yoke for housing the coils extending to the toothed parts and the end turns of the coils.

Also, the coils extending to the toothed parts may be housed in a space formed by the insulation parts provided in the bobbin part. The coils may be located adjacent to an insulation part opposite to the housing in the space inside the bobbin part.

Accordingly, in order to secure a sufficient insulation distance, it may be possible to secure sufficient insulation performance without increasing the thickness of the outer circumferential surface of the yoke.

Also, the coils extending to the toothed parts may be electrically separated from the housing by the insulation parts. Furthermore, the coils extending to the toothed parts may be located adjacent to the insulation part opposite to the housing.

Accordingly, it may be possible to achieve insulation caused by an increase in distance between a housing and a coil as well as insulation caused by the insulation part. Thus, it may be possible to secure sufficient insulation performance without a separate change in design even when the magnitude of power applied to the motor part is increased.

Also, an insulation distance may not be needed to secure insulation performance as described above. That is, it may be possible to secure sufficient insulation performance without increasing the width of the yoke-specific outer circumference part.

Accordingly, a number of coils corresponding to an increase in width of the yoke-specific outer circumference part that has been conventionally needed may be additionally wound. Thus, it may be possible to increase the output power of the motor part and the electric compressor.

Also, the coils may be located adjacent to an insulator opposite to the housing. Accordingly, the coils may be spaced apart from the insulator located adjacent to the housing.

Accordingly, it may be possible to reduce the load applied to an insulator located between the coil and the housing and prevent the insulator from being to broken down.

Also, an insulation distance for securing insulation performance may not be needed. Accordingly, even if the space occupied by the yoke-specific outer circumference part of the yoke is reduced, it may be possible to improve sufficient insulation performance.

Accordingly, without increasing the entire size of the yoke, the space in which the coil can be wound may be increased. Therefore, it may be possible to increase the output power of the motor part and the electric compressor without increasing the size of the motor part.

### BRIEF DESCRIPTION OF THE DRAWINGS

FIG. 1 is a cross-sectional view showing an internal structure of a monitor unit according to a conventional art.

FIG. 2 is a perspective view showing an electric compressor according to an embodiment of the present disclosure.

FIG. 3 is an exploded perspective view showing the configuration of the electric compressor of FIG. 2 according to an embodiment of the present disclosure.

FIG. 4 is a cross-sectional view showing the configuration of the electric compressor of FIG. 2 according to an embodiment of the present disclosure.

FIG. 5 is a cross-sectional view showing the configuration of a motor part according to an embodiment of the present disclosure.

FIG. 6 is a plan view showing a coupling relationship between a coil and a yoke provided in the motor part of FIG. 5 according to an embodiment of the present disclosure.

FIG. 7 is a cross-sectional view showing a positional relationship of part A of FIG. 5 between a coil and a plan view showing a coupling relationship between a coil and a bobbin part provided in the motor part of FIG. 5 according to an embodiment of the present disclosure.

FIG. 8 is a cross-sectional view showing a motor part of part A of FIG. 5 including a rigidity reinforcement part according to an embodiment of the present disclosure.

FIG. 9 is a cross-sectional view showing a motor part of part A of FIG. 5 including a rigidity reinforcement part according to another embodiment of the present disclosure.

FIG. 10 is a cross-sectional view showing a motor part of part A of FIG. 5 including a rigidity reinforcement part according to an embodiment of the present disclosure.

FIG. 11 is a cross-sectional view showing a motor part of part A of FIG. 5 including a rigidity reinforcement part according to yet another embodiment of the present disclosure.

FIG. 12 is a cross-sectional view showing a motor part of part A of FIG. 5 including a rigidity reinforcement part according to yet another embodiment of the present disclosure.

FIG. 13 is a cross-sectional view showing a motor part of part A of FIG. 5 including a rigidity reinforcement part according to yet another embodiment of the present disclosure.

FIG. 14 is a cross-sectional view showing a motor part of part A of FIG. 5 including a rigidity reinforcement part according to yet another embodiment of the present disclosure.

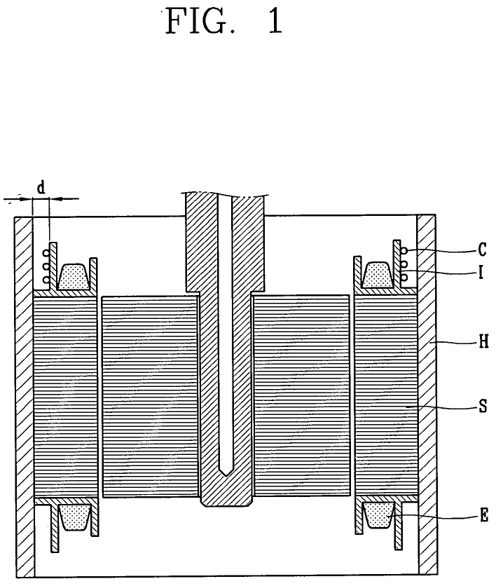

### DETAILED DESCRIPTION

An electric compressor 10 according to an embodiment of the present disclosure will be described below in detail with respect to the accompanying drawings.

Descriptions of some elements are omitted herein so as to clarify the technical features of the present disclosure.

### 1. Definition of Terms

It will be understood that when an element is referred to as being “connected with” another element, the element can be connected with the another element or intervening elements may also be present.

In contrast, when an element is referred to as being “directly connected with” another element, there are no intervening elements present.

A singular representation may include a plural representation unless it represents a definitely different meaning from the context.

The term “refrigerant” as used herein refers to any medium that takes heat away from a low-temperature object and transport the teat to a high-temperature object. In an embodiment, the refrigerator may include carbon dioxide (CO2), R134a, R1234yf, and the like.

The term “printed circuit board” (PCB) as used herein refers to a substrate for forming an electronic circuit by fixing electronic components such as an integrated circuit, a resistor, and a condenser to a surface of a printed wiring board and by connecting the components by means of wiring or the like.

The term “inverter element” as used herein refers to an electronic circuit device using semiconductor. In an embodiment, the inverter element may be a switching element.

In an embodiment, the inverter element may refer to a component or device that is provided as a switching element to have a function of opening or closing a circuit without using contact points.

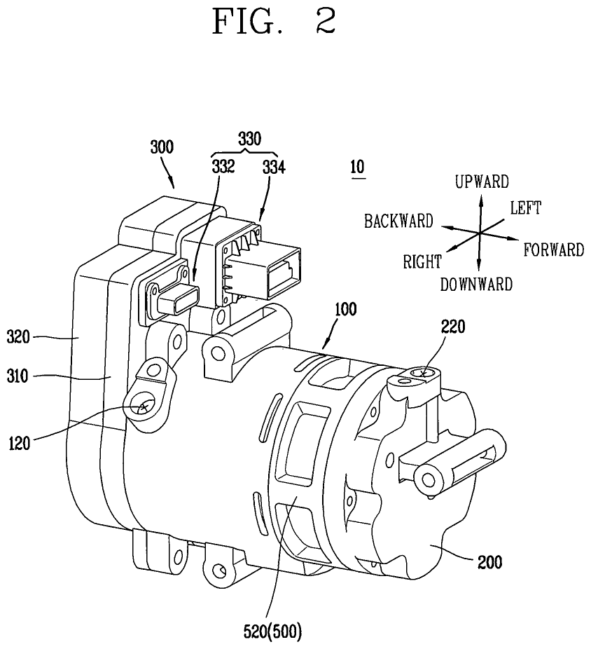

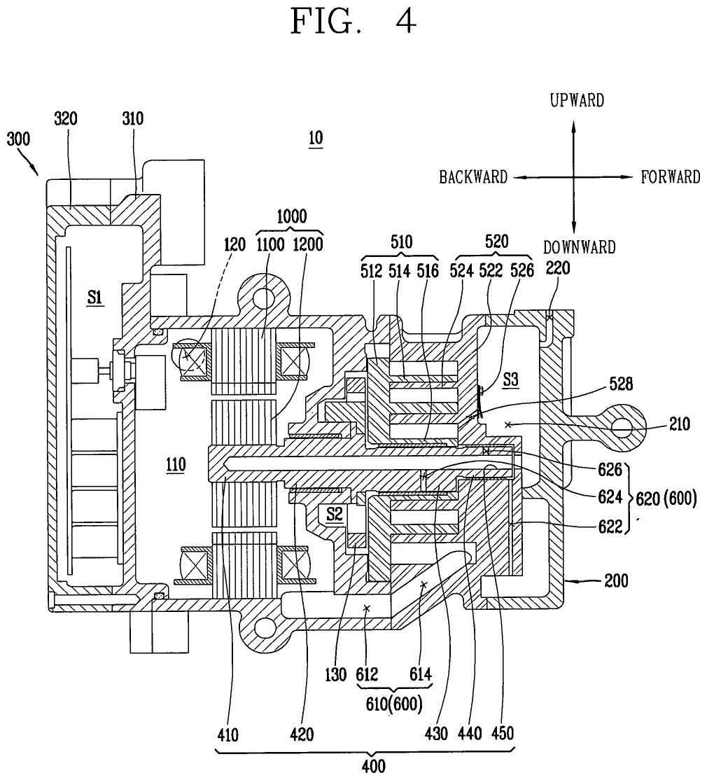

The terms “front,” “rear,” “upper,” “lower,” “right,” and “left” as used herein will be understood with reference to the coordinate systems shown in FIGS. 2 and 4.

### 2. Description of Electric Compressor 10 According to Embodiment of Present Disclosure

Referring to FIGS. 2 to 4, the electric compressor 10 according to an embodiment of the present disclosure may comprise a main housing 100, a rear housing 200, an inverter 300, a rotary shaft part 400, a compression part 500, a flow path part 600, and a motor part 1000.

The elements of the electric compressor 10 according to an embodiment of the present disclosure will be described with reference to an embodiment of the present disclosure with reference to FIGS. 2 to 4, and the motor part 1000 will be described below.

(1) Description of Main Housing 100

The main housing 100 may form a portion of the external appearance of the electric compressor 10. Also, the main housing 100 may form a body part of the electric compressor 10 and may have a space formed therein to house a device provided in the electric compressor 10.

In detail, the rotary shaft part 400, the compression part 500, and the motor part 1000 may be housed in the inner space of the main housing 100.

The main housing 100 may be provided in a cylindrical shape extending lengthwise, that is, along the front-rear direction in the shown embodiment. The main housing 100 may have any shape capable of housing the device of the electric compressor 10.

However, considering that refrigerant introducing into the main housing is compressed with high pressure, it may be preferable that the main housing 100 be formed in a cylindrical shape, which is a shape with high pressure resistance.

A fixed scroll 520 of the compression part 500 to be described later may be connected in fluid communication with one side in the length direction of the main housing 100, that is, the front side of the main housing 100 in the shown embodiment.

After the refrigerant introduced into the main housing 100 is compressed in the compression part 500, the compressed refrigerant may be introduced into a discharge chamber S3 through a discharge port 528 formed in the fixed scroll 520.

The inverter 300 to be described later may be electrically connected to the other side in the length direction of the main housing 100, that is, the rear side of the main housing 100 in the shown embodiment.

Power and a control signal applied from the inverter 300 may be delivered to the motor part 1000, and the motor part 1000 may be controlled to generate a rotational force used for the compression part 500 to compress the refrigerant.

The main housing 100 may comprise a motor chamber 110, an intake port 120, and an Oldham ring 130.

The motor chamber 110 may be a space where the motor part 1000 is housed. The motor chamber 110 may be defined as an inner space of the main housing 100.

The motor chamber 110 may be partitioned by an inner surface of the main housing 100. That is, the motor chamber 110 may be a space surrounded by the inner surface of the main housing 100.

When the motor part 1000 is housed in the motor chamber 110, an outer surface of a stator 1100 of the motor part 1000 may be fixed on the inner surface of the main housing 100. Thus, the stator 1100 may not rotate even when power and a control signal are applied from the inverter 300 to the motor part 1000.

The intake port 120 may enable the inside and outside of the main housing 100 to communicate with each other. The refrigerant may be introduced into the main housing 100 through the intake port 120. The introduced refrigerant may pass through the motor chamber 110, a back-pressure chamber S2, and the discharge chamber S3 in sequence, and may be compressed and then discharged to the outside of the electric compressor 10 through an exhaust port 220 to be described later.

The intake port 120 may be located on one side of the main housing 100 opposite to the rear housing 200 and the fixed scroll 520, that is, on a rear outer circumferential surface of the main housing 100 in the shown embodiment.

Also, the intake port 120 may be formed as a circular through-hole passing through the main housing 100.

The location and shape of the intake port may be determined to any location and shape capable of enabling the inside and the outside of the housing 100 to communicate with each other.

However, considering that a large amount of heat is generated in the inverter device housed in the inverter 300 to be described later and that the refrigerant introduced into the main housing 100 serves to cool the generated heat, it may be preferable that the intake port 120 be located adjacent to the inverter 300.

The Oldham ring 130 may be provided between the main housing 100 and an orbiting scroll 510 of the compression part 500 to be described later.

The Oldham ring 130 may prevent rotation of the orbiting scroll 510. Also, the Oldham ring 130 may deliver the rotational force of the motor part 1000 delivered by the rotary shaft part 400 to the orbiting scroll 510.

To this end, the Oldham ring 130 may be integrally and rotatably coupled to the rotary shaft part 400 and the orbiting scroll 510. In other words, the Oldham ring 130 may be fixedly coupled to the rotary shaft part 400 and the orbiting scroll 510.

Accordingly, when the motor part 1000 is operated, the Oldham ring 130, the rotary shaft part 400, and the orbiting scroll 510 may be integrally rotated.

As a result, the Oldham ring 130 may enable the orbiting scroll 510 to be rotated only when the motor part 1000 is operated.

In an embodiment, an anti-rotation mechanism including a pin and a ring may be provided instead of the Oldham ring 130.

The Oldham ring 130 may be replaced with any member configured to prevent rotation of the orbiting scroll 510 and integrally rotating the rotary shaft part 400 and the orbiting scroll 510.

(2) Description of Rear Housing 200

The rear housing 200 may form a portion of the external appearance of the electric compressor 10. In detail, the rear housing 200 may be located on one side of the main housing 100, that is, in front of the main housing 100 in the shown embodiment. The rear housing 200 may form the external of the electric compressor 10 together with the main housing 100.

A fixed scroll 520 of the compression part 500 to be described later may be located between the rear housing 200 and the main housing 100. That is, the main housing 100, the fixed scroll 520, and the rear housing 200 may be sequentially connected in fluid communication with one another.

Alternatively, the fixed scroll 520 may be housed in the main housing 100. In this case, the rear housing 200 may be directly connected to the main housing 100.

The rear housing 200 may be configured to communicate with the main housing 100. Refrigerant introduced into the main housing 100 through the intake port 120 of the main housing 100 may be compressed in the compression part 500 and then introduced into the rear housing 200.

In the shown embodiment, the rear housing 200 may be provided in the shape of a cap having a circular cross-section. The shape of the rear housing 200 may be changed, but it may be preferable that the shape of the rear housing 200 may be changed according to those of the main housing 100 and the fixed scroll 520.

The rear housing 200 may comprise a space part 210 and an exhaust port 220.

The space part 210 may be formed by recessing one surface of the rear housing 200. In detail, the space part 210 may be a recessed part of one surface of the rear housing 200 opposite to the fixed scroll 520.

As described above, one side of the rear housing 200, that is, the rear side of the rear housing 200 in the shown embodiment may be coupled in fluid communication with the fixed scroll 520.

In this case, the discharge chamber S3 may be defined by the space part 210 and one surface of the fixed scroll 520 opposite to the rear housing 200. The discharge chamber S3 may be defined as a space formed on an upper side among spaces between the rear housing 200 and the fixed scroll 520.

The refrigerant compressed in the compression part 500 may be introduced into the discharge chamber S3. In detail, a fluid mixture of the compressed refrigerant and oil supplied to the compression part 500 may be introduced into the discharge chamber S3.

The fluid mixture introduced into the discharge chamber S3 may be discharged to the outside of the electric compressor 10 through the exhaust port 220 after an oil separation process.

The exhaust port 220 may be a passage through which the compressed refrigerant is discharged to the outside of the electric compressor 10. The exhaust port 220 may enable the inside and the outside of the rear housing 200 to communicate with each other. In detail, the exhaust port 220 may enable the outside of the rear housing 200 to communicate with the discharge chamber S3.

In an embodiment, the exhaust port 220 may be formed as a through-hole.

In the shown embodiment, the exhaust port 220 may be formed on an upper side of the rear housing 200. The location of the exhaust port 220 may be changed to any location capable of enabling the inside and the outside of the rear housing 200 to communicate with each other.

As described above, the main housing 100, the rear housing 200, and the compression part 500 to be described later may be connected to and may communicate with one another. Accordingly, refrigerant introduced into the electric compressor 10 through the intake port 120 may be compressed in the compression part 500 and then discharged to the outside of the electric compressor 10 through the exhaust port 220.

Although not shown, an oil discharge passage (not shown) configured to discharge oil from the discharge chamber S3 may be formed in the housing 200.

The oil separated from the fluid mixture in the discharge chamber S3 may be discharged through the oil discharge passage (not shown) and may be collected in an oil chamber (not shown).

The oil collected in the oil chamber (not shown) may be supplied to the compression part 500 by an oil flow path part 620 of the flow path part 600 to be described later and may be used as a lubricant for smooth rotation of the orbiting scroll 510.

(3) Description of Inverter 300

The inverter 300 may receive a control signal and power for driving the electric compressor 10, and more specifically, the motor part 1000 to be described later from the outside and may apply the control signal and power to the motor part 1000.

To this end, the inverter 300 may house an inverter device (not shown) including an insulated gate bipolar transistor (IGBT) in an inner space.

The inverter 300 may be located on one side of the main housing 100. The inverter 300 may be located on one side of the main housing 100 opposite to the rear housing 200, that is, on the rear side of the main housing 100 in the shown embodiment.

The inverter 300 may be disposed at any location capable of receiving a control signal and power from the outside and applying the control signal and power to the motor part 1000.

The inverter 300 may be electrically connected to the main housing 100. The connection may allow the inverter 300 to apply the control signal and power to the motor part 1000.

In an embodiment not shown, the inverter 300 may communicate with the main housing 100. In the embodiment, the refrigerant introduced through the intake port 120 may directly cool the inverter device (not shown) housed in the inverter 300.

The inverter 300 may comprise an inverter housing 310, an inverter cover 320, and a connector 330. Also, although not shown, the inverter 300 may comprise a printed circuit board (not shown), an inverter bracket (not shown), and an inverter device (not shown).

The inverter housing 310 may form the external appearance of the inverter 300 together with the inverter cover 320.

The front side of the inverter housing 310 may be coupled to the main housing 100. In an embodiment, the inverter housing 310 may be connected in fluid communication with the main housing 100. In the above embodiment, the inverter device (not shown) may be directly cooled by the refrigerant introduced into the main housing 100.

The rear side of the inverter housing 310 may be coupled to the inverter cover 320. A separate fastening member (not shown) may be provided for coupling with the inverter cover 320.

An inner space formed by coupling the inverter housing 310 and the inverter cover 320 may be defined as an inverter chamber S1 for housing a printed circuit board (not shown) and an inverter device (not shown).

The connector 330 to which power and a control signal is applied from the outside may be located on an upper side of the inverter housing 310.

The inverter cover 320 may form the external appearance of the inverter 300 together with the inverter housing 310. The inverter cover 320 may be located behind the inverter housing 310. The inverter cover 320 may be coupled to the inverter housing 310 with a predetermined space formed therebetween.

The inverter cover 320 may be coupled to the inverter housing 310 by a separate fastening means (not shown).

The connector 330 may be a part to which power and a control signal are input from the outside. The power and control signal applied to the connector 330 may be delivered to the motor part 1000, and thus a rotational force for the electric compressor 10 compressing refrigerant may be generated.

In the shown embodiment, the connector 330 may be located on the upper front side of the inverter housing 310. The connector 330 may be provided at any location capable of receiving power and a control signal from the outside.

The connector 330 may comprise a communication connector 332 for receiving a control signal and a power connector 334 for receiving power. Alternatively, the connector 330 may be provided as a single connector for receiving both of the power and the control signal.

A process of applying the power and control signal to the inverter device (not shown) housed in the inverter chamber S1 through the connector 330 to control the motor part 1000 is well known in the art, and thus a detailed description thereof will be omitted.

The printed circuit board (not shown) may generate a control signal for controlling the motor part 1000 to be described later and may deliver the control signal to the motor part 1000. That is, the printed circuit board (not shown) may operate as an inverter.

Various electrical and electronic components for controlling the motor part 1000 may be electrically connected to the printed circuit board (not shown). That is, a connection pin (not shown) of the inverter device (not shown) to be described later may be electrically connected to the printed circuit board (not shown).

To this end, a plurality of connection pin coupling holes (not shown) may be formed to pass through the printed circuit board (not shown).

The inverter bracket (not shown) may support the printed circuit board (not shown) and the inverter device (not shown).

Also, a plurality of through-holes (not shown) to which the connection pin 362 may be through-coupled may be formed in an inverter bracket (not shown) for the coupling of the inverter device (not shown).

It may be preferable that the inverter bracket (not shown) be formed of durable and thermally conductive material.

The inverter device (not shown) may apply or block a control signal or the like for enabling the printed circuit board (not shown) to function as an inverter. That is, the inverter device (not shown) may substantially serve as the inverter 300 together with the printed circuit board (not shown).

One side of the inverter device (not shown) may be brought into contact with an inverter device coupling part (not shown) of the inverter bracket (not shown).

The connection pin (not shown) may be provided in the inverter device (not shown). The connection pin (not shown) may electrically connect the inverter device (not shown) and the printed circuit board (not shown). The connection pin (not shown) may be connected to the printed circuit board (not shown) through the inverter bracket (not shown).

(4) Description of Rotary Shaft Part 400

The rotary shaft part 400 may deliver a rotational force generated by rotation of the motor part 1000 to the orbiting scroll 510.

To this end, one side of the rotary shaft part 400, that is, the rear side of the rotary shaft part 400 in the shown embodiment may be coupled to a rotor 1120 of the motor part 1000. Also, the other side of the rotary shaft part 400, that is, the front side of the rotary shaft part 400 in the shown embodiment may be coupled to the orbiting scroll 510.

In the shown embodiment, the rotary shaft part 400 may be provided in a cylindrical shape extending lengthwise, but the shape of the rotary shaft part 400 may be any shape capable of delivering the rotational force of the motor part 1000 to the compression part 500.

The rotary shaft part 400 may comprise a shaft part 410, a main bearing part 420, an eccentric part 430, a sub-bearing part 440, and a fueling guide flow path 450.

The shaft part 410 may be rotatably coupled to the rotor 1120 of the motor part 1000. The shaft part 410 may be located on one side of the rotary shaft part 400 adjacent to the rotor 1120.

The main bearing part 420 may be radially and rotatably supported by a shaft coupling part (not shown) provided in the main housing 100. In other words, the main bearing part 420 may be a part where the rotary shaft part 400 is to be coupled to the main housing 100.

To this end, the main bearing part 420 may be formed to have a radius larger than that of the shaft part 410. Also, the main bearing part 420 may be located on one side of the shaft part 410, that is, on the front side opposite to the rotor 1120 in the shown embodiment.

A balance weight 422 may be provided on the rear side of the main bearing part 420. The balance weight 422 may adjust the center of gravity of the rotary shaft part 400 to allow the rotary shaft part 400 to stably rotate along with the rotation of the motor part 1000.

The eccentric part 430 may be rotatably coupled to the rotary shaft coupling part 516 of the orbiting scroll 510 of the compression part 500. The eccentric part 430 may be formed to have a central shaft different from that of the rotary shaft part 400. In other words, when the rotary shaft part 400 is rotated, the eccentric part 430 may be rotated around a shaft different from the central shaft of the rotary shaft part 400.

Thus, the orbiting scroll 510 coupled to the eccentric part 430 may be eccentrically rotated relative to the rotation of the motor part 1000. As a result, refrigerant may be compressed in a space between an orbiting wrap 514 of the orbiting scroll 510 and a fixed wrap 524 of the fixed scroll 520.

For the purpose of the eccentric rotation, the eccentric part 430 may be formed to have a cross-section having a center of gravity different from that of the central shaft of the rotary shaft part 400.

The eccentric part 430 may be located on one side of the main bearing part 420, that is, on the front side opposite to the shaft part 410 in the shown embodiment.

A third oil flow path 626 to be described later may be formed to pass through the outer circumferential surface of the eccentric part 430. The oil separated from the compressed refrigerant may be re-supplied to the compression part 500 through the third oil flow path 626.

The sub-bearing part 440 may be rotatably coupled to and radially supported by a rotary shaft coupling part (not shown) of the fixed scroll 520 of the compression part 500. The sub-bearing part 440 may pass through the rotary shaft coupling part 516 of the orbiting scroll 510.

In detail, the eccentric part 430 may be through-coupled to a rotary shaft coupling part 516 formed on an orbiting end plate part 512 of the orbiting scroll 510. Also, the sub-bearing part 440 may be rotatably coupled to the rotary shaft coupling part (not shown) of the fixed scroll 520 through the rotary shaft coupling part 516 of the orbiting scroll 510.

In the shown embodiment, the sub-bearing part 440 may be formed to have a radius smaller than that of the eccentric part 430. Accordingly, the sub-bearing part 440 may not be radially constrained by the rotary shaft coupling part 516 of the orbiting scroll 510.

The sub-bearing part 440 may be located on one side of the eccentric part 430, that is, on the front side opposite to the main bearing part 420 in the shown embodiment.

The fueling guide flow path 450 may be a passage through which the oil separated from the compressed refrigerant is to be introduced into the third oil flow path 626. To this end, the fueling guide flow path 450 may communicate with the third oil flow path 626 and a first oil flow path 622.

The fueling guide flow path 450 may be formed to pass through the sub-bearing part 440 lengthwise, that is, along the front-rear direction in the shown embodiment. In an embodiment, the fueling guide flow path 450 may be formed on the central shaft of the sub-bearing part 440.

(5) Description of Compression Part 500

The compression part 500 may be rotated along with the rotation of the motor part 1000 and may substantially serve to compress refrigerant. The compression part 500 may be rotatably connected to the motor part 1000 by the rotary shaft part 400. That is, the rotary shaft part 400, the motor part 1000, and the compression part 500 may be rotated together.

The compression part 500 may comprise the orbiting scroll 510 and the fixed scroll 520.

The orbiting scroll 510 may be rotated along with the rotation of the motor part 1000. In detail, the orbiting scroll 510 may be rotatably connected to the eccentric part 430 of the rotary shaft part 400.

When the motor part 1000 is rotated, the eccentric part 430 may be rotated around a central shaft different from those of the rotary shaft part 400 and the motor part 1000. That is, the eccentric part 430 may be rotated eccentrically with respect to the central shaft of the motor part 1000.

Thus, the orbiting scroll 510 rotatably coupled to the eccentric part 430 may be rotated eccentrically with respect to the central shaft of the motor part 1000. As will be described below, the fixed scroll 520 may be disposed to have the same central shaft as the motor part 1000.

Accordingly, the orbiting scroll 510 may be eccentrically rotated relative to the fixed scroll 520. Thus, refrigerant may be compressed in a space between the orbiting wrap 514 of the orbiting scroll 510 and the fixed wrap 524 of the fixed scroll 520.

The orbiting scroll 510 may be housed in the main housing 100. In detail, the orbiting scroll 510 may be located on one side of the motor part 1000 in an inner space of the main housing 100, that is, on the front side of the motor part 1000 in the shown embodiment.

The orbiting scroll 510 may comprise the orbiting end plate part 512, the orbiting wrap 514, and the rotary shaft coupling part 516.

The orbiting end plate part 512 may form one side of the orbiting scroll 510. In the shown embodiment, the orbiting end plate part 512 may form the rear side of the orbiting scroll 510.

One surface of the orbiting end plate part 512, that is, the front surface of the orbiting end plate part 512 in the shown embodiment may be in contact with the rear surface of the fixed scroll 520.

The orbiting wrap 514 may be coupled to the fixed wrap 524 of the fixed scroll 520 with a predetermined space formed therebetween. The orbiting wrap 514 may be rotated eccentrically with respect to the rotary shaft part 400 while coupled to the fixed wrap 524. Thus, refrigerant may be compressed in the space between the orbiting wrap 514 and the fixed wrap 524.

The orbiting wrap 514 may be formed to protrude from the orbiting end plate part 512. In the shown embodiment, the orbiting wrap 514 may be formed to protrude from the front surface of the orbiting end plate part 512.

In the shown embodiment, the orbiting wrap 514 may be spirally formed, but may have any shape capable of being engaged with the fixed wrap 524 and eccentrically rotated relative to the fixed wrap 524.

The rotary shaft coupling part 516 may be a part to which the rotary shaft part 400 is to be coupled. In detail, the eccentric part 430 of the rotary shaft part 400 may be through-coupled to the rotary shaft coupling part 516.

The rotary shaft coupling part 516 may be formed to pass through the orbiting end plate part 512. In the shown embodiment, the rotary shaft coupling part 516 may be formed to pass through the orbiting scroll 510 in the front-rear direction.

It may be preferable that the radius of the rotary shaft coupling part 516 be determined to be a bit greater than or equal to the outer diameter of the eccentric part 430 so that the eccentric part 430 is through-coupled to the rotary shaft coupling part 516.

The fixed scroll 520 may not be rotated irrespective of the rotation of the motor part 1000. Accordingly, when the motor part 1000 is rotated, the orbiting scroll 510 may be eccentrically rotated relative to the fixed scroll 520.

The fixed scroll 520 may be located on one side of the main housing 100, that is, on the front side opposite to the inverter 300 in the shown embodiment. The outer surface of the fixed scroll 520 may be exposed to the outside.

One surface of the fixed scroll 520, that is, the rear surface in the shown embodiment may be in contact with the front surface of the main housing 100. Also, a separate fastening member (not shown) may be provided to couple the fixed scroll 520 and the main housing 100.

One surface of the fixed scroll 520, that is, the front surface in the shown embodiment may be coupled to the rear housing 200 with a predetermined space formed therebetween.

As described above, the discharge chamber S3 may be defined by an upper side of the space.

The fixed scroll 520 may be rotatably coupled to the orbiting scroll 510. As described above, the fixed scroll 520 may be fixed, and the orbiting scroll 510 may be rotated relative to the fixed scroll 520.

The fixed scroll 520 may comprise a fixed end plate part 522, a fixed wrap 524, a discharge valve 526, and a discharge port 528.

Also, a rotary shaft coupling part (not shown) may be formed in the fixed scroll 520, and the sub-bearing part 440 of the rotary shaft part 400 may be rotatably coupled to the fixed scroll 520.

However, as described above, the fixed scroll 520 may not be rotated along with the rotation of the motor part 1000. Therefore, it can be seen that the rotary shaft coupling part (not shown) of the fixed scroll 520 supports the rotary shaft part 400.

The fixed end plate part 522 may form one side of the fixed scroll 520. In the shown embodiment, the fixed end plate part 522 may form the rear side of the fixed scroll 520.

One surface of the fixed end plate part 522, that is, the front surface in the shown embodiment may be in contact with the front surface of the orbiting scroll 510.

In the shown embodiment, a plurality of blind holes may be formed on the outer circumferential surface of the fixed end plate part 522. The plurality of blind holes may be formed to reduce the weight of the electric compressor 10, and the shape and number thereof may be changed.

The fixed wrap 524 may be coupled to the orbiting wrap 514 of the orbiting scroll 510 with a predetermined space formed therebetween. When the orbiting scroll 510 is rotated along with the rotation of the motor part 1000 after the fixed wrap 524 is coupled to the orbiting wrap 514, refrigerant may be compressed in the space between the fixed wrap 524 and the orbiting wrap 514.

The fixed wrap 524 may be formed to protrude from the fixed end plate part 522. In the shown embodiment, the fixed wrap 524 may be formed to protrude rearward from the fixed end plate part 522.

In the shown embodiment, the fixed wrap 524 may be spirally formed, but may have any shape capable of being engaged with the orbiting wrap 514 such that the orbiting wrap 514 may be eccentrically rotated relative to the fixed wrap 524.

The discharge valve 526 may be configured to open or close the discharge port 528, which may be a passage through which refrigerant compressed by the relative rotation between the orbiting scroll 510 and the fixed scroll 520 is to be introduced into the discharge chamber S3.

In an embodiment, the discharge valve 526 may be provided as a check valve such as a reed valve that restricts a flow of fluid in a single direction depending on the pressure.

The discharge valve 526 may be located on one side of the fixed end plate part 522 opposite to the fixed wrap 524, that is, on the front side of the fixed end plate part 522 in the shown embodiment. Also, the discharge valve 526 may be configured to cover the discharge port 528.

When the pressure of the compressed refrigerant is greater than or equal to a predetermined pressure, the discharge valve 526 may open the discharge port 528. Thus, the compressed refrigerant may be introduced into the discharge chamber S3.

When the pressure of the compressed refrigerant is less than a predetermined pressure, the discharge valve 526 may close the discharge port 528. Thus, the less compressed refrigerant may be prevented from being introduced into the discharge chamber S3.

The discharge port 528 may be a passage through which the compressed refrigerant is to be introduced by the orbiting scroll 510 and the fixed scroll 520. The discharge port 528 may connect the space formed between the orbiting wrap 514 and the fixed wrap 524 in fluid communication with the discharge chamber S3.

The discharge port 528 may be opened or closed. In detail, the discharge valve 526 may be provided in the discharge port 528 and may be opened or closed depending on the pressure of the compressed refrigerant.

The refrigerant discharged through the discharge port 528 may be discharged to the outside of the electric compressor 10 through the exhaust port 220 via the discharge chamber S3.

(6) Description of Flow Path Part 600

The flow path part 600 may be a passage through which refrigerant and oil flow. The flow path part 600 may be formed over the main housing 100 and the rear housing 200.

In an embodiment not shown, the flow path part 600 may be formed even in the inverter 300. In this case, as described above, the refrigerant may directly cool various kinds of inverter devices (not shown) constituting the inverter 300.

The flow path part 600 may comprise a refrigerant flow path part 610 and an oil flow path part 620.

The refrigerant flow path part 610 may be a passage through which refrigerant flows. The refrigerant flow path part 610 may be partitioned by a space formed inside the main housing 100. Alternatively, the refrigerant flow path part 610 may be formed by a separate refrigerant flow path forming member (not shown).

The refrigerant flow path part 610 may comprise a first refrigerant flow path 612 and a second refrigerant flow path 614.

The first refrigerant flow path 612 may enable the motor chamber 110 to communicate with the second refrigerant flow path 614. Refrigerant introduced into the motor chamber 110 of the housing 100 through the intake port 120 may move to the second refrigerant flow path 614 through the first refrigerant flow path 612.

In the shown embodiment, the first refrigerant flow path 612 may be located in a lower space inside the main housing 100. The first refrigerant flow path 612 may be in any location capable of enabling the motor chamber 110 to communicate with the second refrigerant flow path 614.

The second refrigerant flow path 614 may enable the first refrigerant flow path 612 to communicate with the compression part 500. In detail, refrigerant having passed through the first refrigerant flow path 612 may be introduced into the second refrigerant flow path 614.

The refrigerant introduced into the second refrigerant flow path 614 may be moved to a space formed between the orbiting scroll 510 and the fixed scroll 520 and may be compressed to have a predetermined pressure. The compressed refrigerant may be introduced into the discharge chamber S3 through the discharge port 528 of the fixed scroll 520.

A refrigerant guide member (not shown) configured to constrain the movement direction of the refrigerant flowing therein may be provided in the refrigerant flow path part 610.

The oil flow path part 620 may be a passage through which oil flows. The oil flow path part 620 may be partitioned by a space formed inside the main housing 100 and the rear housing 200. Alternatively, the oil flow path part 620 may be formed by a separate oil flow path forming member (not shown).

The oil flow path part 620 may comprise a first oil flow path 622, a second oil flow path 624, and a third oil flow path 626.

The first oil flow path 622 may enable an oil chamber (not shown) formed in an inner space of the electric compressor 10 to communicate with the fueling guide flow path 450. Oil separated from refrigerant in the discharge chamber S3 may be discharged to an oil discharge passage (not shown) and collected in an oil chamber (not shown).

The oil collected in the oil chamber (not shown) may be moved to the fueling guide flow path 450 of the rotary shaft part 400 through the first oil flow path 622. In order to move the oil smoothly, the first oil flow path 622 may be provided with a power supply device (not shown) for providing a transfer force to oil.

The second oil flow path 624 may enable a space between the eccentric part 430 and the rotary shaft coupling part 516 to communicate with the fueling guide flow path 450.

The oil introduced through the second oil flow path 624 may be supplied between the eccentric part 430 and the rotary shaft coupling part 516 of the orbiting scroll 510. In other words, the second oil flow path 624 may be introduced into a space between the rotary shaft coupling part 516 and the outer circumferential surface of the eccentric part 430.

Thus, friction caused by the rotation of the orbiting scroll 510 may be reduced, and thus it may be possible to efficiently compress refrigerant.

The third oil flow path 626 may enable a space between the sub-bearing part 440 and the rotary shaft coupling part (not shown) of the fixed scroll 520 to communicate with the fueling guide flow path 450.

The oil introduced through the third oil flow path 626 may be supplied between the sub-bearing part 440 and the rotary shaft coupling part (not shown) of the fixed scroll 520. In other words, the third oil flow path 626 may be introduced into a space between the outer circumferential surface of the sub-bearing part 440 and the rotary shaft coupling part (not shown) of the fixed scroll 520.

Thus, friction caused by the rotation of the rotary shaft part 400, and thus it may be possible to efficiently compress refrigerant.

The oil introduced into the compression part 500 may be mixed with the refrigerant introduced into the compression part 500 through the refrigerant flow path part 610. The fluid mixture of the compressed refrigerant and the oil may be introduced into the discharge chamber S3, and a process of separating the refrigerant and the oil may be performed first.

### 2. 2. Description of Motor Part 1000 According to Embodiment of Present Disclosure

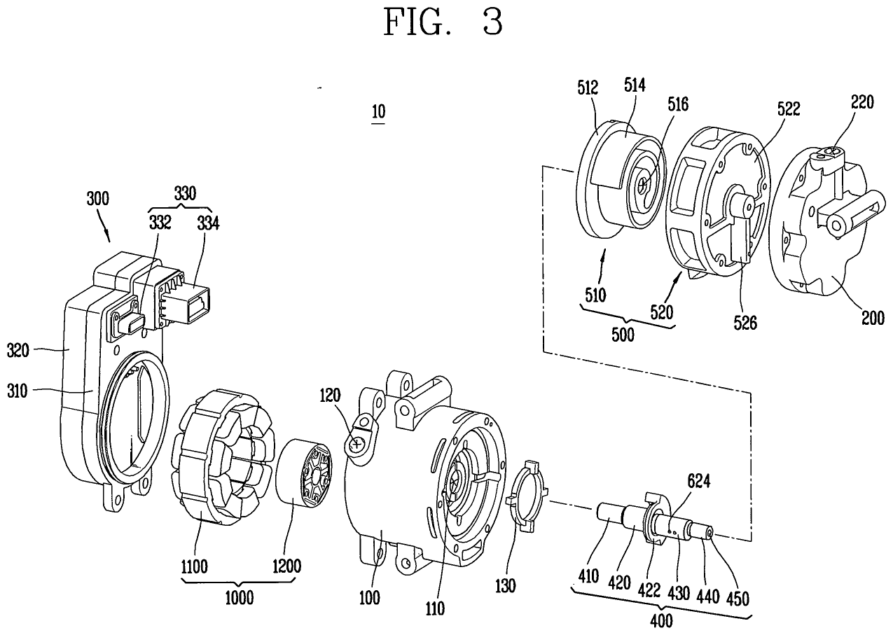

Referring to FIGS. 3 and 4, the electric compressor 10 according to an embodiment of the present disclosure may comprise the motor part 1000. The motor part 1000 may operate according to power and a control signal applied from the inverter 300.

A rotational force generated by the operation of the motor part 1000 may be delivered to the compression part 500 through the rotary shaft part 400. The orbiting scroll 510 of the compression part 500 may be rotated by the delivered rotational force to compress refrigerant introduced into a space between the orbiting wrap 514 and the fixed wrap 524.

Also, the motor part 1000 according to an embodiment of the present disclosure may be formed in the structure for improving insulation and output power.

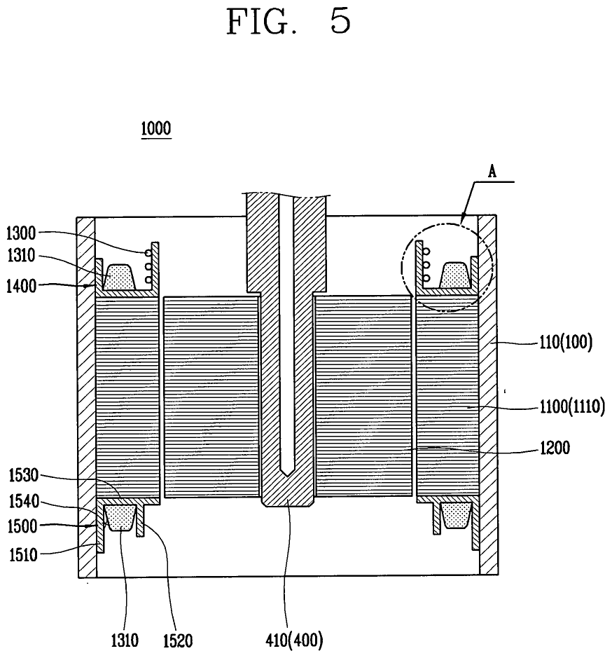

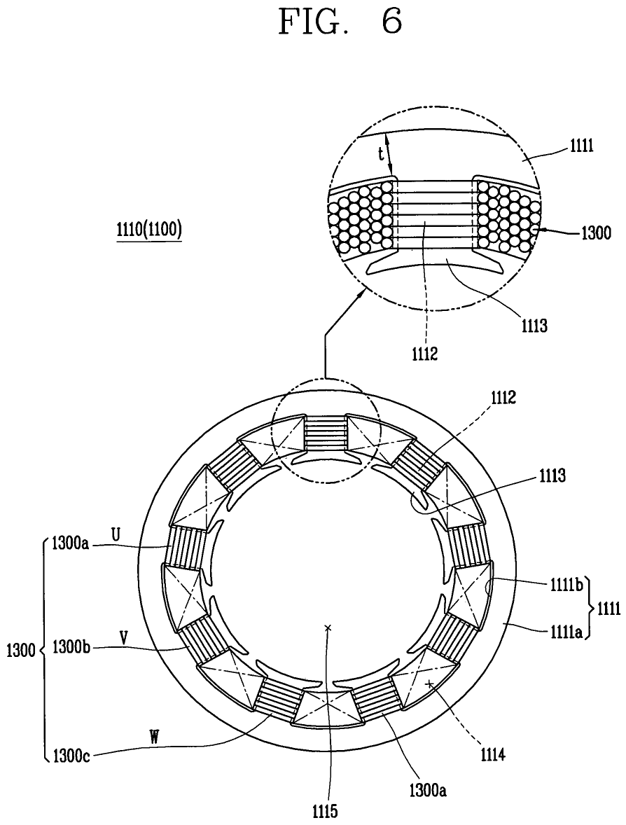

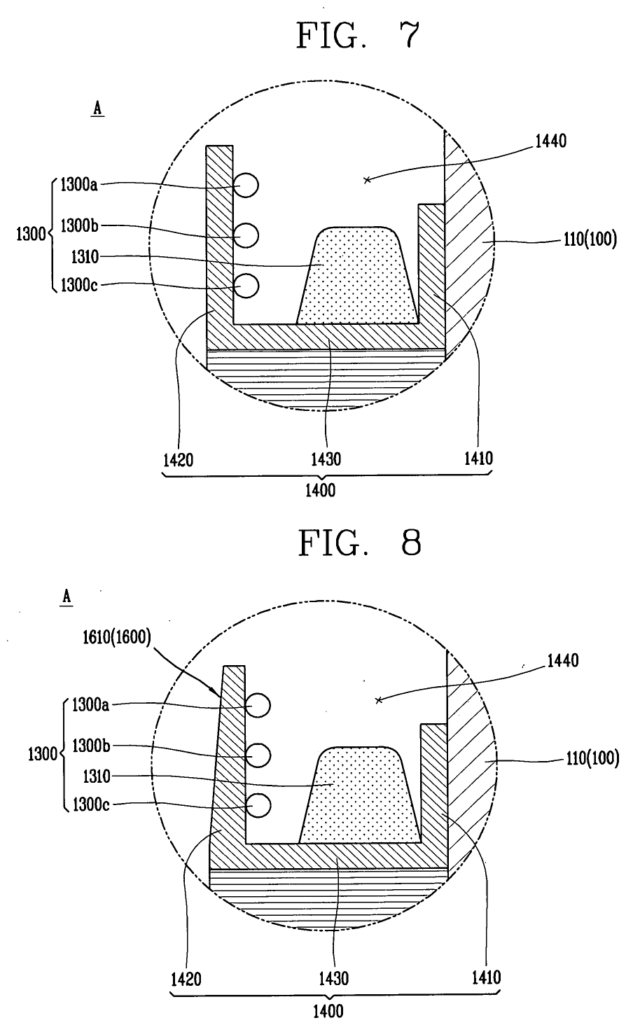

The motor part 1000 according to an embodiment of the present disclosure will be described in detail below with reference to FIGS. 5 to 14. The motor part 1000 according to the shown embodiment may comprise a stator 1100, a rotor 1200, a coil 1300, a bobbin part 1400, a coil housing part 1500, and a rigidity reinforcement part 1600.

(1) Description of Stator 1100

The stator 1100 may be fixedly coupled to the main housing 100. Also, the stator 1100 may have a hollow portion formed therein, and the rotor 1200 may be rotatably housed therein. In this case, the rotor 1200 may be spaced a predetermined distance from the stator 1100.

The stator 1100 may comprise a plurality of coils 1300. In detail, the plurality of coils 1300 may be wound around the stator 1100.

The stator 1100 may be electrically connected to the inverter 300. The stator 1100 may be configured to receive power and a control signal from the inverter 300.

When the power and the control signal are applied from the inverter 300, a magnetic field may be formed by the plurality of coils 1300 wound around the stator 1100.

The magnetic field formed by the plurality of coils 1300 may exert an electromagnetic force on a magnetic material provided in the rotor 1200. Thus, the rotor 1200 may be rotated relative to the stator 1100.

In the shown embodiment, the stator 1100 may have a cylindrical shape with a hollow portion formed therein. The stator 1100 may be formed to extend lengthwise, that is, forward and rearward in the shown embodiment.

The stator 1100 may comprise a yoke 1110.

The yoke 1110 may be provided as a circular plate member. The yoke 1110 may have a changeable shape.

However, the outer circumferential surface of the stator 1100 formed by the yoke 1110 may be coupled to the motor chamber 110 having a cylindrical shape. In consideration of this, it may be preferable that the shape of the yoke 1110 be determined to correspond to the shape of the motor chamber 110. The yoke 1110 may be formed by stacking a plurality of electrical steel sheets. The yoke 1110 may form the body of the stator 1100. The plurality of coils 1300 may be wound around the yoke 1110 to exert an electromagnetic force on a permanent magnet of the rotor 1200.

The yoke 1110 may comprise a yoke-specific outer circumference part 1111, a toothed part 1112, a pole shoe part 1113, a coil winding space part 1114, and a rotor housing part 1115.

The yoke-specific outer circumference part 1111 may form a radial outside of the yoke 1110. In other words, the yoke-specific outer circumference part 1111 may be a member that forms a yoke-specific outer circumferential surface 1111a and a yoke-specific inner circumferential surface 1111b. The yoke-specific outer circumference part 1111 may be formed to a predetermined thickness t in the radial direction of the yoke 1110.

The shape of the toothed part 1112 and the size of the coil winding space part 1114 may be determined by the thickness t of the yoke-specific outer circumference part 1111.

In detail, as the thickness t of the yoke-specific outer circumference part 1111 increases, a space occupied by the yoke-specific outer circumference part 1111 may increase from the radial outside of the yoke 1110 toward the center of the yoke 1110. Thus, the coil winding space part 1114 may decrease in size.

Also, the rotor housing part 1115 may have a space enough to house the rotor 1120. Accordingly, the degree of protrusion of the toothed part 1112 may be decreased in order to secure the size of the rotor housing part 1115.

On the contrary, as the thickness t of the yoke-specific outer circumference part 1111 decreases, the space occupied by the yoke-specific outer circumference part 1111 may decrease from the radial outside of the yoke 1110 toward the center of the yoke 1110. Thus, the coil winding space part 1114 may increase in size.

Furthermore, a space enough to form the rotor housing part 1115 may be secured, and thus the restriction of the protruding length of the toothed part 1112 may be reduced.

The motor part 1000 according to an embodiment of the present disclosure may decrease the thickness t of the yoke-specific outer circumference part 1111, and thus it may be possible to accomplish the above-described advantageous effects. This will be described in detail below.

The radially outer surface of the yoke-specific outer circumference part 1111 may be defined as the yoke-specific outer circumferential surface 1111a. The yoke-specific outer circumferential surface 1111a may form an outer surface of the yoke 1110.

The yoke-specific outer circumferential surface 1111a may be fixedly coupled to the motor chamber 110 of the main housing 100. That is, the yoke-specific outer circumferential surface 1111a and the inner circumferential surface of the motor chamber 110 may be in contact with each other.

Thus, even when the rotor 1200 is rotated, the stator 1100 may not be rotated.

The radially inner surface of the yoke-specific outer circumference part 1111 may be defined as the yoke-specific inner circumferential surface 1111b. The yoke-specific inner circumferential surface 1111b may form an inner surface of the yoke 1110.

A plurality of such toothed parts 1112 may be formed to protrude from the yoke-specific inner circumferential surface 1111b toward the center of the yoke 1110, that is, radially inward. In this case, the center of the yoke 1110 may be disposed coaxially with the central shaft C.A of the stator 1100.

The coil winding space part 1114 may be formed in a portion of the yoke-specific inner circumferential surface 1111b where the plurality of toothed parts 1112 are not formed, that is, a space between the plurality of toothed parts 1112.

Each of the toothed parts 1112 may be a part where the coils 1300 is wound around the stator 1100. A plurality of toothed parts 1112 may be formed. In the shown embodiment, a total of nine toothed parts 112 may be formed. The number of toothed parts 1112 may not be limited, but it may be preferable that the number of toothed parts 1112 be a multiple of 3. As will be described below, this may be to allow currents of three phases to flow through the coils 1300 wound around the toothed parts 1112.

Each of the toothed parts 1112 may be formed to protrude from the yoke-specific inner circumferential surface 1111b toward the center of the yoke 1110, that is, radially inward.

It may be preferable that the plurality of toothed parts 1112 protrude to the same length. This may be to allow the space of the rotor housing part 1115 having an outer circumference defined by an end of each of the toothed part 1112 to be formed in a circular shape.

The plurality of toothed parts 1112 may be spaced a predetermined distance from one another. That is, the plurality of toothed part 1112 may be continuously disposed in the circumferential direction of the yoke-specific outer circumference part 1111. In this case, the plurality of toothed part 1112 may be spaced a predetermined distance from one another in the circumferential direction of the yoke-specific outer circumference part 1111.

The space formed by the toothed parts 1112 being spaced apart from one another may be defined as the coil winding space part 1114.

A pole shoe part 1113 may be located at an end of a corresponding toothed part 1112. The pole shoe part 1113 may prevent the coils 1300 wound around the toothed part 1112 from being pushed and moved to the rotor housing part 1115.

The pole shoe part 1113 may be formed at a predetermined angle with respect to the protrusion direction of the toothed part 1112. In the shown embodiment, the pole shoe part 1113 may be formed to extend perpendicular to the protrusion direction of the toothed part 1112. The pole shoe part 1113 may have any shape capable of fixing the coils 1300 in the coil winding space part 1114.

The coil winding space part 1114 may be a space where the coils 1300 are wound around the toothed part 1112 and housed by reciprocating in the length direction of the stator 1100. The coil winding space part 1114 may be defined as a space formed by the plurality of toothed parts 1112 being spaced apart from one another. That is, a plurality of coil winding space parts 1114 may be formed like the plurality of toothed parts 1112.

A coil 1300 inserted into any one coil winding space part 1114 may extend in the length direction of the yoke 1110. The coil 1300 reaching one end in the length direction of the yoke 1110 may be inserted into another adjacent coil winding space part 1114 across the toothed part 1112.

Subsequently, the coil 1300 may extend to the other side in the length direction of the yoke 1110, and then may be inserted back into the coil winding space part 1114 across the toothed part 1112.

By repeating the above process, the coils 1300 may be wound around any one toothed part 1112. Also, the above process may be performed on the plurality of toothed parts 1112 and the plurality of coil winding space parts 1114.

That is, any one of the plurality of toothed parts 1112 and two adjacent coil winding space parts 1114 may be defined as one group. Also, a coil 1300 through which a current of a specific phase flows may be wound around to the group. The wound coils 1300 extend toward another toothed part 1112.

In this case, electric current flow may occur between the coil 1300 and the main housing 100. The motor part 1000 according to an embodiment of the present disclosure may comprise a structure for preventing the electric current flow. This will be described in detail below.

The rotor housing part 1115 may be a space of the stator 1100 where the rotor 1200 is to be housed. As described above, the stator 1100 may have a cylindrical shape having a hollow portion formed therein. The rotor housing part 1115 may function as the hollow portion.

The rotor 1200 housed in the rotor housing part 1115 may be spaced a predetermined distance from the outer circumferential surface of the rotor housing part 1115. Therefore, the rotation of the rotor 1200 may not exert a physical force on the stator 1100.

The size of the rotor housing part 1115 may be defined by the protrusion length of the plurality of toothed parts 1112 and the pole shoe part 1113 provided at an end of each of the toothed parts 1112.

(2) Description of Rotor 1200

The rotor 1200 may generate a rotational force used by the compression part 500 to compress refrigerant.

The rotor 1200 may be rotatably housed in an inner space of the stator 1100, and in particular, in the rotor housing part 1115. Also, the rotor 1200 may be spaced a determined distance from the inner circumferential surface of the stator 1100. That is, the rotor 1200 and the stator 1100 may not be in contact with each other.

The rotor 1200 may comprise a plurality of permanent magnets (not shown). When power and a control signal are applied from the inverter 300, a plurality of coils 1300 wound around the stator 1100 may form a magnetic field.

The plurality of permanent magnets (not shown) provided in the rotor 1200 may receive an electromagnetic force from the magnetic field, and thus the rotor 1200 may be rotated.

The rotor 1200 may be connected to the orbiting scroll 510 of the compression part 500 by the rotary shaft part 400. The rotary shaft part 400 may be configured to also rotate the orbiting scroll 510 when the rotor 1200 is rotated. Thus, when the rotor 1200 is rotated, the compression part 500 may compress refrigerant.
A process of rotating the rotor 1200 and a process of compressing refrigerant along with the rotation of the orbiting scroll 510 are well known in the art, and thus a detailed description thereof will be omitted.

(3) Description of Coil 1300

A plurality of coils 1300 may be provided and wound around the stator 1100. The coils 1300 may be configured to receive power from the inverter 300. When power is applied, each of the wound coils 1300 may form a magnetic field and may provide an electromagnetic field capable of rotating the rotor 1200.

Currents of different phases may flow through the plurality of coils 1300. In an embodiment, the phases may include U-phase, V-phase, and W-phase. Accordingly, in the shown embodiment, a total number of three coils 1300 may be provided (see FIG. 5).

The coils 1300 may be wound around the toothed parts 1112 of the yoke 1110. In detail, the coils 1300 may be repeatedly wound around the toothed part 1112 by reciprocating between any one toothed part 1112 and two coil winding space parts 1114 adjacent to the toothed part 1112.

On one side and the other side of the yoke 1110, the coils 1300 may extend from any one coil winding space part 1114 to the other coil winding space part 1114. In this case, the coils 1300 should cross the toothed part 1112 located between the coil winding space parts 1114.

By repeating the above process, the coils may be wound in the length direction of the toothed part 1112. The coils 1300 wound around the surfaces of the toothed parts 1112 on one side and the other side in the length direction of the yoke 1110 may be defined as a coil end turn 1310. It will be understood that the volume of the coil end turn 1310 may increase as the number of windings of the coils 1300 increases.

As described above, the plurality of toothed parts 1112 and the plurality of coil winding space parts 1114 may be provided. As described above, the number of toothed parts 1112 may be equal to the number of coil winding space parts 1114.

Accordingly, a coil 1300 through which a current of a specific phase flows may be wound around each toothed part 1112. Also, two coils 1300 through which currents of different phases flow may be housed in each coil winding space part 1114. The coils 1300 housed in each coil winding space part 1114 may be spaced apart from each other to prevent electric current flow therebetween. The plurality of coils 1300 may be classified into a first coil 1300a, a second coil 1300b, and a third coil 1300c. The coils 1300a, 1300b, and 1300c may be configured such that currents of different phases flow therethrough.

In an embodiment, a U-shape current may flow through the first coil 1300a. Also, a V-phase current may flow through the second coil 1300b, and a W-phase current may flow through the third coil 1300c.

The toothed parts 1112 wound by the first coil 1300a, the second coil 1300b, and the third coil 1300c may be located adjacent to one another. In other words, the toothed part wound by the first coil 1300a, the toothed part wound by the second coil 1300b, and the toothed part wound by the third coil 1300c may be sequentially disposed in the circumferential direction of the yoke 1110.

Also, as described above, in an embodiment, nine toothed parts 1112 may be formed. In this case, the wound coils 1300a, 1300b, and 1300c may be sequentially and repeatedly disposed.

That is, the plurality of toothed parts 1112 may be configured such that the U-phase, V-phase, and W-phase, which are the phases of the current flowing through the wound coils 1300a, 1300b, and 1300c, are alternatively repeated.

A coil 1300 completely wound around any one toothed part 1112 may extend toward another toothed part 1112.

For example, the first coil 1300a through which the U-phase current flows may be wound around any one toothed part 1112. In this case, the second coil 1300b through which the V-phase current flows may be wound around a toothed part 1112 adjacent to the toothed part 1112, and the third coil 1300c through which the W-phase current may be wound around a toothed part 1112 subsequent to the adjacent toothed part 1112.

Accordingly, the first coil 1300a may pass through the two toothed parts 1112, and may be wound around the third toothed part 1112. When the first coil 1300a crosses the two toothed parts 1112, electric current flow may likely occur between the coils 1300a, 1300b, and 1300c.

Accordingly, the first coil 1300a may extend apart from the toothed parts 1112. This may be accomplished by the bobbin part 1400 to be described later.

(4) Description of Bobbin Part 1400

After a coil 1300 is completely wound around a corresponding toothed part 1112, the bobbin part 1400 may form a passage for the coil 1300 extending toward another toothed part 1112. Also, the bobbin part 1400 may prevent electric current flow between the main housing 100 and the extending coil 1300.

The bobbin part 1400 may be located on one side in the length direction of the yoke 1110. In the shown embodiment, the bobbin part 1400 may be located on one side of the yoke facing the compression part 500. The bobbin part 1400 may be in contact with the yoke 1110. Preferably, the bobbin part 1400 may be fixedly coupled to the yoke 1110.

The bobbin part 1400 may be formed along the circumferential direction of the yoke 1110. As described above, the yoke 1110 may be formed to have a circular cross-section. The bobbin part 1400 may be formed in a ring shape extending along the yoke-specific outer-circumference part 111 of the yoke 1110.

The bobbin part 1400 may be formed of a material with high electrical insulation. This may be to prevent unnecessary electric current flow between the yoke 1110, the coil 1300, and the main housing 100.

The bobbin part 1400 may comprise a first insulation part 1410, a second insulation part 1420, a contact surface 1430, and a coil housing space part 1440.

The first insulation part 1410 may form the outer circumference of the bobbin part 1400. That is, the first insulation part 1410 may be defined as the outer circumferential surface of the bobbin part 1400 which has a ring shape.

The first insulation part 1410 may be in contact with the inner circumferential surface of the motor chamber 110 of the main housing 100. Preferably, the first insulation part 1410 may be fixed on the inner circumferential surface of the motor chamber 110.

Thus, even when the rotor 1200 is rotated, the stator 1100 may stably maintain the fixed state.

The first insulation part 1410 may be formed to extend in the length direction of the yoke 1110. The first insulation part 1410 may be formed to extend to any length capable of preventing electric current flow between the coil 1300 and the main housing 100.

In an embodiment, the first insulation part 1410 may be formed to have an extending length smaller than or equal to that of the second insulation part 1420. This may be due to the difference in location between the coil end turn 1310 located adjacent to the first insulation part 1410 and the coil 1300 that is located adjacent to the second insulation part 1420 to move between the toothed parts 1112.

The coil end turn 1310 may be located adjacent to the first insulation part 1410. In an embodiment, the coil end turn 1310 may be in contact with the first insulation part 1410.

The second insulation part 1420 may be located on one side of the first insulation part 1410 opposite to the inner circumferential surface of the motor chamber 110.

The second insulation part 1420 may form the inner circumference of the bobbin part 1400. That is, the second insulation part 1420 may be defined as the inner circumferential surface of the bobbin part 1400 which has a ring shape.

The second insulation part 1420 may be set according to the pole shoe part 1113 of the yoke 1110 and the length direction of the yoke 1110. That is, the second insulation part 1420 may be located on a line formed by extending the pole shoe part 1113 in the length direction of the yoke 1110.

That is, the second insulation part 1420 may be located on a line formed by extending the outer circumference of the rotor housing part 1115 in the length direction.

The second insulation part 1420 may be formed to extend in the length direction of the yoke 1110. The second insulation part 1420 may be formed to extend to any length capable of preventing electric current flow between the coil 1300 and the main housing 100.

In an embodiment, the second insulation part 1420 may have an extending length smaller than or equal to that of the first insulation part 1410. This may be due to the difference in location between the coil located adjacent to the second insulation part 1420 and the coil end turn 1310 located adjacent to the first insulation part 1410.

The second insulation part 1420 may be configured to prevent electric current flow between the main housing 100 and the coil 1300 extending between the toothed parts 1112. The plurality of coils 1300 may be located adjacent to the second insulation part 1420. In an embodiment, the plurality of coils 1300 may be in contact with the second insulation part 1420.

The plurality of coils 1300 extending to the toothed parts 1112 may be wound around the second insulation part 1420. The plurality of coils 1300 may be wound around the second insulation part 1420 by a tension force toward the central shaft C.A of the stator 1100.

That is, the plurality of coils 1300 may be wound around the second insulation part 1420 while being pulled toward the central shaft C.A of the stator 1100.

A space between the second insulation part 1420 and the first insulation part 1410 may be defined as the coil housing space part 1440. The coils 1300 extending toward the other toothed parts 1112 may be housed in the coil housing space part 1440.

The contact surface 1430 may be a part where the bobbin part 1400 is in contact with the yoke 1110. Also, the contact surface 1430 may form a lower side of the bobbin part 1400 and thus may be defined as a base surface of the bobbin part 1400. The contact surface 1430 may be fixedly coupled to the yoke 1110.

The contact surface 1430 may extend at predetermined angles with respect to the first insulation part 1410 and the second insulation part 1420. In an embodiment, the contact surface 1430 may extend perpendicularly to the first insulation part 1410 and the second insulation part 1420.

The contact surface 1430 may communicate with the coil winding space part 1114. Also, the other portion of the contact surface 1430 may be formed to overlap the toothed parts 1112. In other words, the contact surface 1430 may have the same cross-section as the yoke 1110.

In the above embodiment, the coils 1300 may be wound around all of the toothed parts 1112 and the contact surface 1430. In this case, the coil end turn 1310 may be located on the contact surface 1430.

In an embodiment not shown, the contact surface 1430 may be formed to have an inner diameter smaller than the yoke 1110. In other words, an end of the contact surface 1430 facing the central shaft C.A of the stator 1100 may have a length shorter than the protrusion length of the toothed parts 1112.

The above embodiment may be applied when an insulation distance does not need to be increased.

The coil 1300 and the coil end turn 1310 extending between the toothed parts 1112 may be housed in the coil housing space part 1440.

The coil housing space part 1440 may be defined by the first insulation part 1410, the second insulation part 1420, and the contact surface 1430.

(5) Description of Coil Housing Part 1500

The coil housing part 1500 may be configured to house the coil end turn 1310 opposite to the coil end turn 1310 housed in the coil housing space part 1440. That is, in the shown embodiment, the coil housing part 1500 may house the coil end turn located on one side opposite to the compression part 500.

The coil housing part 1500 may be located on one side of the yoke 1110, that is, on one side opposite to the bobbin part 1400 in the shown embodiment. The coil housing part 1500 may be located adjacent to the yoke 1110. Preferably, the coil housing part 1500 may be fixed coupled to the yoke 1110.

The coil housing part 1500 may be formed along the circumferential direction of the yoke 1110. The yoke 1110 may be formed to have a circular cross-section, and thus the coil housing part 1500 may be formed in a ring shape extending along the yoke-specific outer circumference part 1111 of the yoke 1110.

The coil housing part 1500 may be formed of a material with high electrical insulation. This may be to prevent unnecessary electric current flow between the yoke 1110, the coil 1300, and the main housing 100.

The coil housing part 1500 may comprise an outer circumferential surface member 1510, an inner circumferential surface member 1520, a base surface 1530, and an end turn housing part 1540.

The outer circumferential surface member 1510 may form the outer circumference of the coil housing part 1500. That is, the outer circumferential surface member 1510 may be defined as the outer circumferential surface of the coil housing part 1500 which has the ring shape.

The outer circumferential surface member 1510 may be in contact with the inner circumferential surface of the motor chamber 110 of the main housing 100. Preferably, the outer circumferential surface member 1510 may be fixedly coupled to the inner circumferential surface of the motor chamber 110.

Thus, even when the rotor 1200 is rotated, the stator 1100 may stably maintain the fixed state.

The outer circumferential surface member 1510 may be formed to extend in the length direction of the yoke 1110. The outer circumferential surface member 1510 may be formed to extend to any length capable of preventing electric current flow between the coil 1300 and the main housing 100.

In an embodiment, the outer circumferential surface member 1510 may be formed to be longer than the inner circumferential surface member 1520. This may be to effectively prevent electric current flow between the main housing 100 and the coil end turn 1310 housed in the coil housing part 1500.

The inner circumferential surface member 1520 may be located on one side of the outer circumferential surface member 1510 opposite to the inner circumferential surface of the motor chamber 110.

The inner circumferential surface member 1520 may form the inner circumference of the coil housing part 1500. That is, the inner circumferential surface member 1520 may be defined as the inner circumferential surface of the coil housing part 1500 which has the ring shape.

The inner circumferential surface member 1520 may have an inner side, that is, one side surface opposite to the central shaft C.A of the stator 1100 located in contact with the coil end turn 1310. Thus, the coil end turn 1310 may be stably housed.

The inner circumferential surface member 1520 may be formed to extend in the length direction of the yoke 1110. The inner circumferential surface member 1520 may be formed to extend to any length capable of preventing electric current flow between the coil end turn 1310 and the outside.

The base surface 1530 may be a part where the coil housing part 1500 is in contact with the yoke 1110. The base surface 1530 may be fixedly coupled to the yoke 1110.

The base surface 1530 may extend at predetermined angles with respect to the outer circumferential surface member 1510 and the inner circumferential surface member 1520. In an embodiment, the base surface 1530 may be formed perpendicular to the outer circumferential surface member 1510 and the inner circumferential surface member 1520.

The base surface 1530 may communicate with the coil winding space part 1114. Also, the other portion of the base surface 1530 may be formed to overlap the toothed parts 1112. In other words, the base surface 1530 may have the same cross-section as the yoke 1110.

In the above embodiment, the coils 1300 may be wound around all of the toothed parts 1112 and the base surface 1530. Thus, the coil end turn 1310 may be located on the base surface 1530.

One end of the base surface 1530, that is, one end facing the central shaft C.A of the stator 1100 may extend to corresponding to an end of the toothed part 1112. Thus, the coupling between the coil housing part 1500 and the yoke 1110 may be stably maintained.

The coil end turn 1310 may be housed in the end turn housing part 1540. The end turn housing part 1540 may be defined by the outer circumferential surface member 1510, the inner circumferential surface member 1520, and the base surface 1530.

(6) Description of Rigidity Reinforcement Part 1600

The motor part 1000 according to an embodiment of the present disclosure may be configured to prevent electric current flow between the main housing 100 and the coil 1300 extending to the toothed parts 1112 through the above structure of the bobbin part 1400.

However, the second insulation part 1420 wound by the coil 1300 may be provided as a plate member. Accordingly, rigidity reinforcement sufficient to withstand a tension force generated by winding the coil 1300 may be required for the second insulation part 1420.

Thus, the motor part 1000 according to an embodiment of the present disclosure may comprise the rigidity reinforcement part 1600 configured to reinforce the rigidity of the second insulation part 1420.

The rigidity reinforcement part 1600 according to an embodiment of the present disclosure will be described in detail below with reference to FIGS. 8 to 14.

The rigidity reinforcement part 1600 may be provided in the bobbin part 1400 and may be configured to reinforce rigidity. In detail, the rigidity reinforcement part 1600 may reinforce the rigidity of the second insulation part 1420 such that the second insulation part 1420 wound by the coil 1300 can overcome a tension force applied by the coil 1300.

The rigidity reinforcement part 1600 may be provided in any structure capable of reinforcing the rigidity of the second insulation part 1420 and further the rigidity of the bobbin part 1400.

Referring to FIG. 8, the rigidity reinforcement part 1600 according to the shown embodiment may comprise a tapered member 1610.

The tapered member 1610 may be configured to increase the cross-sectional area of the second insulation part 1420. In detail, the tapered member 1610 may be inclined in a direction from one side of the second insulation part 1420 connected to the contact surface 1430 to the other side thereof (an upper side in the shown embodiment).

By the tapered member 1610, the cross-sectional area of the second insulation part 1420 on one side in contact with the contact surface 1430 may be greater than the cross-section area in a direction away from the contact surface 1430.

Stress generated by winding the coil 1300 may be concentrated on a portion where the second insulation part 1420 and the contact surface 1430 are in contact with each other. The tapered member 1610 may mitigate the concentration of stress by increasing the cross-sectional area of the portion.

Furthermore, the second insulation part 1420 including the tapered member 1610 may have one surface adjacent to the central shaft C.A of the stator 1100. In this case, the surface may be inclined in a direction toward the motor chamber 110.

Accordingly, it may be possible to prevent the coil 1300 wound around the second insulation part 1420 from slipping away from the coil housing space part 1440. Furthermore, a mechanical moment by which one end of the second insulation part 1420 is rotated in a direction toward the central shaft C.A of the stator 1100 (counterclockwise in the shown embodiment) may be canceled.

In the shown embodiment, the tapered member 1610 may be formed such that one side of the second insulation part 1420 adjacent to the contact surface 1430 has a smaller cross-sectional area than the other side thereof.

Alternatively, the tapered member 1610 may be configured such that the cross-sectional area of the second insulation part 1420 increases uniformly in the extending direction of the second insulation part 1420. Alternatively, the tapered member 1610 may be provided in the same format an opposite location in the shown embodiment, that is, on one side of the second insulation part 1420 facing the first insulation part 1410.

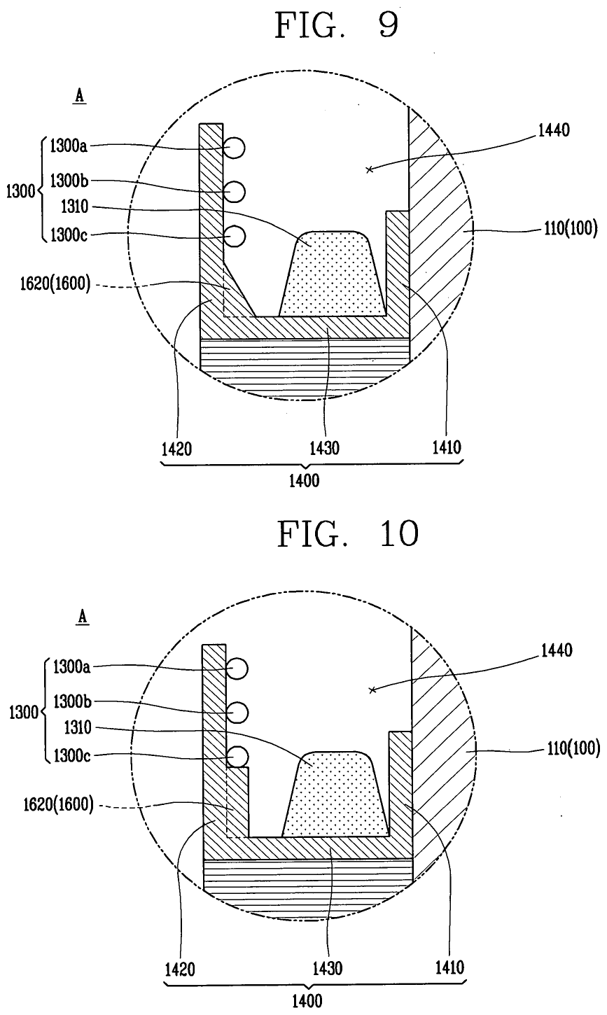

Referring to FIGS. 9 and 10, the rigidity reinforcement part 1600 according to the shown embodiment may comprise an inner reinforcement member 1620.

The inner reinforcement member 1620 may be configured to reinforce the rigidity of a portion where the second insulation part 1420 and the contact surface 1430 are connected to each other.

As described above, stress generated by winding the coil 1300 may be concentrated at a connection portion between the second insulation part 1420 and the contact surface 1430. Considering that the magnitude of stress applied to a specific part is inversely proportional to the size of the cross-sectional area, the size of the cross-sectional area may be increased to reduce and disperse the stress.

The inner reinforcement member 1620 may be provided at the portion where the second insulation part 1420 and the contact surface 1430 are connected to each other and may be configured to increase the cross-sectional area of the portion.

In the embodiment shown in FIG. 9, the inner reinforcement member 1620 may be inclined in a direction toward the contact surface 1430. That is, in the shown embodiment, the inner reinforcement member 1620 may have a right triangular prism shape having the second insulation part 1420 and the contact surface 1430 as side surfaces.

Also, in the embodiment shown in FIG. 10, the inner reinforcement member 1620 may be in contact with a coil 1300 adjacent to the contact surface 1430 among a plurality of coils 1300 and may have a quadrangular prism shape having the second insulation part 1420 and the contact surface 1430 as side surfaces.

The shape of the inner reinforcement member 1620 may be any shape capable of increasing the cross-sectional area of the connection portion between the second insulation part 1420 and the contact surface 1430 and reinforcing rigidity.

When the inner reinforcement member 1620 is provided, the cross-sectional area of the connection portion between the second insulation part 1420 and the contact surface 1430 may be increased. Thus, stress applied to the portion may be dispersed, and the magnitude of the stress may be decreased.

As a result, the rigidity of the second insulation part 1420 against stress generated by winding the plurality of coils 1300 around the second insulation part 1420 may be increased.

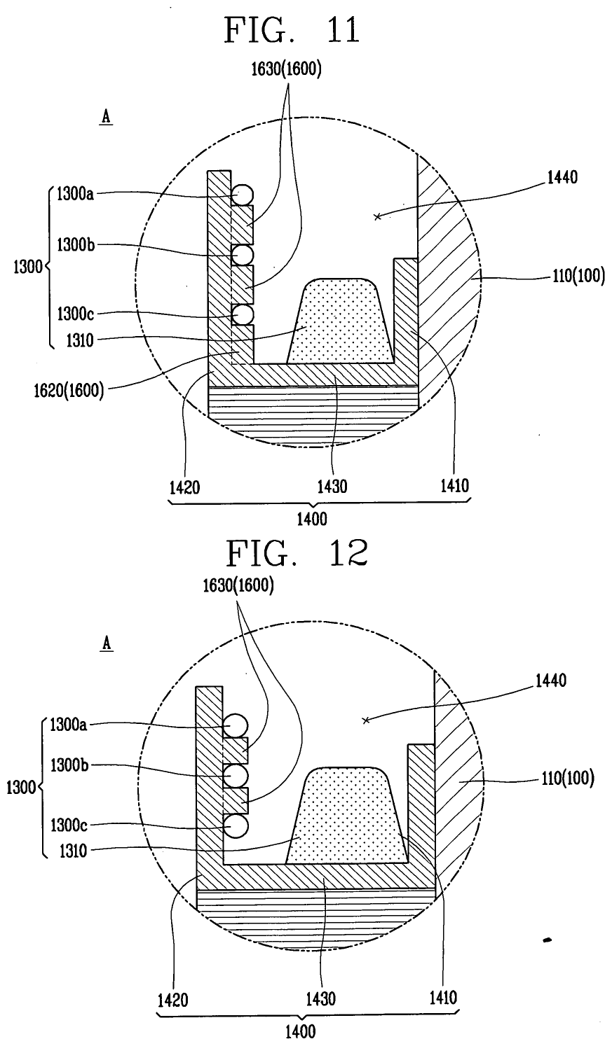

Referring to FIG. 11, the rigidity reinforcement part 1600 according to the shown embodiment may comprise a gap reinforcement member 1630.

The gap reinforcement member 1630 may be provided in each space formed by the plurality of coils 1300 being wound around the second insulation part 1420 and spaced apart from one another. The gap reinforcement member 1630 may be formed to protrude from one surface of the second insulation part 1420 facing the first insulation part 1410.

The plurality of coils 1300 may be wound around the second insulation part 1420 while being pulled toward the central shaft C.A of the stator 1100. Accordingly, a tension force toward the central shaft C.A of the stator 1100 may be applied to a portion of the second insulation part 1420 in contact with the plurality of coils 1300.

The gap reinforcement member 1630 may be configured to increase the rigidity of a portion where the second insulation part 1420 and the plurality of coils 1300 against the tension force. To this end, the gap reinforcement member 1630 may be located in a space formed by the plurality of coils 1300 being spaced apart from one another.

Also, the gap reinforcement member 1630 may serve to secure the spacing of the plurality of coils 1300. As described above, currents of different phases flow through the coils 1300a, 1300b, and 1300c. Accordingly, when the coils 1300a, 1300b, and 1300c are in contact with one another, electric accidents such as short circuits may occur.

The plurality of coils 1300 may be pulled toward the central shaft C.A of the stator 1100. Accordingly, the plurality of coils 1300 may be moved on the insulation part 1420 in the extending direction of the second insulation part 1420.

The gap reinforcement member 1630 may be provided between the plurality of coils 1300 to block physical contact between the coils 1300a, 1300b, and 1300c. To this end, it may be preferable that the degree of protrusion of the gap reinforcement member 1630 be greater than or equal to the diameter of the coils 1300.

The gap reinforcement member 1630 may be provided together with the above-described tapered member 160 and inner reinforcement member 1620.

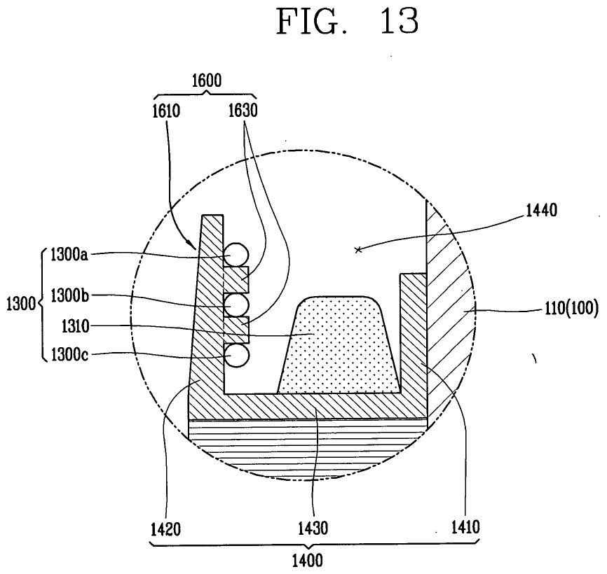

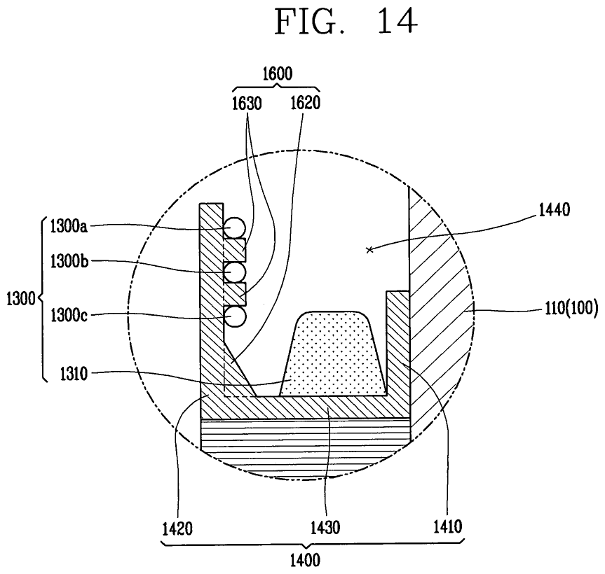

That is, referring to FIG. 12, an embodiment in which the tapered member 1610 and the gap reinforcement member 1630 are provided together is shown. Also, referring to FIGS. 13 and 14, an embodiment in which the inner reinforcement member 1620 and the gap reinforcement member 1630 are provided together is shown.

Also, although not shown, the tapered member 1610 may also be provided together with the gap reinforcement member 1630.

According to this embodiment, not only may the rigidity of the second insulation part 1420 be reinforced, but physical contact between the coils 1300a, 1300b, and 1300c may be blocked. Accordingly, it may be possible to stably operate the electric compressor 10.

### 3. Description of Effects of Motor Part 1000 and Electric Compressor 10 Including Same According to Embodiment of Present Disclosure

According to an embodiment of the present disclosure, the plurality of coils 1300 extending to the toothed parts 1112 may be housed in the coil housing space part 1440 formed by the first insulation part 1410 and the second insulation part 1420. The first insulation part 1410 formed of an insulating material may be located between the main housing 100 and the plurality of coils 1300.

Accordingly, in order to achieve insulation between the main housing 100 and the plurality of coils 1300, it may be possible to secure sufficient insulation performance without increasing an insulation distance. Also, the first insulation part 1410 and the second insulation part 1420 may be provided in the bobbin part 1400, and thus a separate insulating member may not be required.

Also, in the coil housing space part 1440 formed between the first insulation part 1410 and the second insulation part 1420, the coil end turn 1310 may be located adjacent to the first insulation part 1410, and the coils 1300 may be located adjacent to the second insulation part 1420. That is, each coil 1300 may be spaced apart from the first insulation part 1410, and the first insulation part 1410 formed of an insulating member may be located between each coil 1300 and the main housing 100.

Accordingly, it may be possible to sufficiently secure an insulation distance without increasing the thickness t of the yoke-specific outer circumference part 1111 of the yoke 1110. Also, the insulation between the main housing 100 and each coil 1300 may be achieved by the first insulation part 1410 as well as the spacing distance, and thus it may be possible to improve the insulation performance.

Furthermore, since the insulation distance does not need to be increased even when the voltage of power applied to the motor part 1000 is increased, sufficient insulation performance can be secured without excessive design changes.

Also, as described above, it may be possible to secure sufficient insulation performance without increasing the thickness t of the yoke-specific outer circumference part 1111, and thus the protrusion length of the toothed parts 1112 may be increased. Thus, the area of the coil winding space part 1114 formed between the toothed parts 1112 may be increased.

Accordingly, the number of coils 1300 housed in the coil winding space part 1114 may be increased to increase the magnetic flux density. As a result, the output power of the motor part 1000 and the electric compressor 10 may be increased. Furthermore, the motor part 1000 and the electric compressor 10 may be miniaturized to obtain the same output power.

Also, the coil housing space part 1440 may communicate with the coil winding space part 1114. Thus, the coil end turn 1310 as well as the plurality of coils 1300 extending to the toothed parts 1112 may be housed in the coil housing space part 1440.

Accordingly, a structure for housing the coil end turn 1310 and the plurality of coils 1300 extending to the toothed parts 1112 may be simplified.

Also, the coils 1300 may be located adjacent to the second insulation part 1420 spaced apart from the first insulation part 1410. Accordingly, a load applied to the first insulation part 1410 may be decreased to achieve insulation between the main housing 100 and each coil 1300.

Furthermore, the second insulation part 1420 located adjacent to the coils 1300 may be spaced apart from the main housing 100. Accordingly, a load applied to the second insulation part 1420 may also be decreased to achieve insulation between the main housing 100 and each coil 1300.

Accordingly, it may be possible to prevent the first insulation part 1410 and the second insulation part 1420 from being broken down.

The foregoing description has been given of the preferred embodiments, but it will be apparent to those skilled in the art that various modifications and variations can be made in the present disclosure without departing from the spirit or scope of the disclosure as defined in the appended claims.

What is claimed is:

1. A motor part comprising:
a stator comprising a circular section with a predetermined space formed therein and a yoke extending in a length direction;
a plurality of coils wound around the stator; and
a rotor housed in the predetermined space and spaced a predetermined distance from the stator, the rotor being configured to rotate relative to the stator,
wherein,
the stator comprises a bobbin part located on one side in the length direction of the stator and extending along a circumferential direction of the yoke, the bobbin part comprising a first insulation part forming an outer circumference of the bobbin part and a second insulation part forming an inner circumference of the bobbin part, and
the plurality of coils are located between the first insulation part and the second insulation part and wound in a circumferential direction of the bobbin part.

2. The motor part of claim 1, wherein the yoke comprises:
a yoke-specific outer circumference part forming an outer circumference of the yoke;
a plurality of toothed parts protruding toward a center of the yoke from the yoke-specific outer circumference part and spaced a predetermined distance from one another along the outer circumference of the yoke; and
a plurality of coil winding space parts formed between the plurality of toothed parts.

3. The motor part of claim 2, wherein,
the stator further comprises a first coil end turn and a second coil end turn, each formed by winding any one of the plurality of coils around the plurality of toothed parts, and
the first coil end turn is located on the one side in the length direction of the stator and the second coil end turn is located on a side opposite to the one side between the first insulation part and the second insulation part.

4. The motor part of claim 3, wherein,
the plurality of coils are located adjacent to the second insulation part, and
at least one of the first and second coil end turns is spaced a predetermined distance from the plurality of coils and located adjacent to the first insulation part.

5. The motor part of claim 3, wherein,
the plurality of coils are configured to allow currents of different phases to flow therethrough, and
the plurality of coils wound in the circumferential direction of the bobbin part are spaced a predetermined distance from one another to block an electrical connection between the plurality of coils.

6. The motor part of claim 5, wherein,
the currents flowing through the plurality of coils have any one of U-phase, V-phase, and W-phase,
the plurality of coils are wound around the plurality of toothed parts, and
each of the plurality of coils is wound around any one of the plurality of toothed parts such that a phase of a current flowing through a coil wound around a corresponding one of the plurality of toothed parts is alternately changed in the circumferential direction of the yoke.

7. The motor part of claim 1, wherein,
the first insulation part and the second insulation part extend in the length direction of the stator, and
an extension length of the first insulation part is smaller than or equal to an extension length of the second insulation part.

8. The motor part of claim 1, wherein,
the plurality of coils are located adjacent to the second insulation part, and
the second insulation part comprises a rigidity reinforcement unit configured to reinforce a rigidity of the second insulation part.

9. The motor part of claim 8, wherein the rigidity reinforcement part comprises a tapered member configured to increase a cross-sectional area of the second insulation part toward a center of the stator.

10. The motor part of claim 8, wherein the rigidity reinforcement unit comprises:
one side surface of the second insulation part toward the first insulation part; and
an inner reinforcement member extending at a predetermined angle with respect to the one side surface of the second insulation part and contacting a side surface located adjacent to the one side surface in the length direction of the stator.

11. The motor part of claim 8, wherein,
the plurality of coils wound in the circumferential direction of the bobbin part are spaced a predetermined distance from one another to block an electrical connection between the plurality of coils, and
the rigidity reinforcement unit comprises a gap reinforcement member provided in each space formed by the plurality of coils being spaced the predetermined distance from one another.

12. An electric compressor comprising:
a motor part;
a main housing comprising a motor chamber therein to house the motor part;
an inverter located on one side of the main housing, the inverter comprising an inverter device housed therein and configured to control the motor part; and
a compression part configured to be rotated by a rotational force generated due to a rotation of the motor part and compress refrigerant,
wherein,
the motor part comprises:
a stator comprising a circular section with a predetermined space formed therein and a yoke extending in a length direction;
a plurality of coils wound around the stator; and
a rotor housed in the predetermined space and spaced a predetermined distance from the stator, the rotor being configured to rotate relative to the stator,
the stator comprises a bobbin part located on one side in the length direction of the stator and extending along a circumferential direction of the yoke, the bobbin part comprising a first insulation part forming an outer circumference of the bobbin part and a second insulation part forming an inner circumference of the bobbin part, and
the plurality of coils are located between the first insulation part and the second insulation part and wound in a circumferential direction of the bobbin part.

13. The electric compressor of claim 12, wherein,
an outer circumferential surface of the stator is configured to contact an inner circumferential surface of the motor chamber of the main housing, and
one side surface of the first insulation part of the bobbin part is configured to contact the inner circumferential surface of the motor chamber.

14. The electric compressor of claim 12, wherein the yoke comprises:
a yoke-specific outer circumference part forming an outer circumference of the yoke;
a plurality of toothed parts protruding toward a center of the yoke from the yoke-specific outer circumference part and spaced a predetermined distance from one another along the outer circumference of the yoke; and
a plurality of coil winding space parts formed between the plurality of toothed parts.

15. The electric compressor of claim 14, wherein,
the stator further comprises a first coil end turn and a second coil end turn, each formed by winding any one of the plurality of coils around the plurality of toothed parts, and
the first coil end turn located on the one side in the length direction of the stator and the second coil end turn is located on a side opposite to the one side between the first insulation part and the second insulation part.

16. The electric compressor of claim 15, wherein,
the plurality of coils are configured to allow currents of different phases to flow therethrough, and
the plurality of coils wound in the circumferential direction of the bobbin part are spaced a predetermined distance from one another to block an electrical connection between the plurality of coils.

17. The electric compressor of claim 16, wherein,
the currents flowing through the plurality of coils have any one of U-phase, V-phase, and W-phase,
the plurality of coils are wound around the plurality of toothed parts, and
each of the plurality of coils is wound around any one of the plurality of toothed parts such that a phase of a current flowing through a coil wound around a corresponding one of the plurality of toothed parts is alternately changed in the circumferential direction of the yoke.

18. The electric compressor of claim 12, wherein,
the plurality of coils are located adjacent to the second insulation part, and
the second insulation part includes a rigidity reinforcement unit configured to reinforce a rigidity of the second insulation part.
